(19) United States
(12) Patent Application Publication
(10) Pub. No.: US 2004/0239594 A1
(43) Pub. Date: Dec. 2, 2004

(54) Plasma display apparatus and method of driving plasma display panel

(75) Inventor: Mitsuyoshi Makino, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC PLASMA DISPLAY CORPORATION

(21) Appl. No.: 10/853,657

(22) Filed: May 26, 2004

(30) Foreign Application Priority Data
May 28, 2003 (JP) 151225/2003
May 19, 2004 (JP) 149309/2004

(51) Int. Cl. G09G 3/28

(52) U.S. Cl. 345/66

(57) ABSTRACT

A plasma display apparatus includes a plasma display panel (PDP) and a driving control section outputting drive control signals to drive the plasma display panel. The PDP includes a front substrate and a rear substrate. A discharge spaces are formed between the front substrate and the rear substrate. The front substrate includes a scanning electrode, a sustaining electrode and a priming discharge electrode. A priming discharge gap and a display gap are formed between predetermined electrodes. The rear substrate includes a data electrode. The drive control signals directs an operation of distributing a field into subfields, generating a priming discharge in the priming discharge gap in the subfields, and generating the priming discharge in the display gap in at least one of the subfields. The PDP is driven based on the first drive control signal.

### BACKGROUND OF THE INVENTION

1. Field of the Invention

The present invention relates to a plasma display apparatus and a method of driving a plasma display panel (hereinafter referred to as PDP).

2. Description of the Related Art

In a PDP, on the basis of the classification on structure, there are a DC type and an AC type. In the DC type, electrodes are exposed to discharge gas. In the AC type, since electrodes are covered with dielectrics, they are not directly exposed to the discharge gas. Moreover, in the AC type, there are a memory operation type and a refresh operation type. The memory operation type uses a memory function through an electrification accumulation action of the above-mentioned dielectrics. The refresh operation type does not use the memory function.

The schematic structure of the conventional PDP will be described below with reference to the drawings. FIG. 1 is a projection view showing the configuration of the AC type PDP. With reference to FIG. 1, a conventional PDP 100 is provided with a front substrate 1 and a rear substrate 2.

The front substrate 1 is composed of a transparent glass substrate 1a, scanning electrodes 3, sustaining electrodes 4, a transparent dielectric layer 5a and a surface protecting layer 6. The scanning electrodes 3 are arranged on and parallel to the transparent glass substrate 1a. The sustaining electrodes 4 are formed on the transparent glass substrate 1a. The transparent dielectric layer 5a is formed on the transparent glass substrate 1a, and covers the scanning electrodes 3 and the sustaining electrodes 4. The surface protecting layer 6 covers the transparent dielectric layer 5a. The scanning electrodes 3 and the sustaining electrodes 4 are formed in parallel to each other.

The rear substrate 2 is composed of a transparent glass substrate 2a, data electrodes 8, a white dielectric layer 5b, barrier walls 10 and fluorescent layers 7. The data electrodes 8 are formed on the transparent glass substrate 2a. The white dielectric layer 5b is formed on the transparent glass substrate 2a and covers the data electrode 8. The barrier walls 10 are formed on the white dielectric layer 5b. The data electrodes 8 are formed in the direction orthogonal to the scanning electrodes 3 and the sustaining electrodes 4. The fluorescent layers 7 are formed on the side of the barrier wall 10 and the surface of the white dielectric layer 5b. The fluorescent layers 7 convert ultraviolet light, which is generated by the gas discharge, into visible light.

For example, red (R), green (G) and blue (B) of the fluorescent layers 7 are distributed into cells (hereafter, referred to as a PDP cell) of the PDP. Red (R), green (G) and blue (B)are the three primary colors of light.

FIG. 2 is a view showing a section of a PDP cell among a plurality of PDP cells formed on the conventional PDP. The front substrate 1 is fixed to face the rear substrate 2 in an interval of about 100 μm (micrometer). Its periphery is air-tightly sealed with adhesive. The space formed between the front substrate 1 and the rear substrate 2 defines a discharge space 9. The discharge gas composed of helium, neon, xenon or mixture gas of them is filled in this discharge space 9.

In the front substrate 1, a plurality of scanning electrodes 3 and a plurality of sustaining electrodes 4 are formed at a predetermined interval. The scanning electrodes 3 and the sustaining electrodes 4 are composed of transparent conductive material such as ITO and the like. In the scanning electrode 3 and the sustaining electrode 4, to drop a line resistance, a metallic bus electrode 3a is formed and placed on the scanning electrode 3, and a metallic bus electrode 4a is formed and placed on the sustaining electrode 4.

The scanning electrode 3, the sustaining electrode 4, the bus electrode 3a, and the bus electrode 4a are covered with the transparent dielectric layer 5a. The surface protecting layer 6 is formed on the transparent dielectric layer 5a. The surface protecting layer 6 is made of MgO and the like and protects the transparent dielectric layer 5a from the discharge.

On the rear substrate 2, a plurality of data electrodes 8 are formed at a predetermined interval on the transparent glass substrate 2a. The data electrode 8 is covered with the white dielectric layer 5b and the fluorescent layer 7 coated on the white dielectric layer 5b. If the red (R), the green (G) and the blue (B) are distributed into the fluorescent layer 7 of PDP cells, the PDP for color display is obtained.

FIG. 3 is a plan view from the displaying direction of the conventional PDP. The plurality of scanning electrodes 3 and the plurality of sustaining electrodes 4 of the front substrate 1, are respectively orthogonal to the plurality of data electrodes 8 of the rear substrate 2.

FIG. 4 is a plan view of the electrode structure of the color PDP. In the electrode structure of the color PDP, m scanning electrodes Sᵢ (i=1, 2, . . . , m) are formed in a column direction, n data electrodes Dⱼ (j=1, 2, . . . , n) are formed in a row direction. One PDP cell is formed at the crossing. A sustaining electrode Cᵢ is provided as the pair of a scanning electrode Sᵢ, and formed in the column direction, and both are parallel.

The plasma display apparatus will be described below FIG. 5 is a block diagram showing the configuration of the plasma display apparatus manufactured by using the PDP as mentioned above.

The plasma display apparatus 70 has module structure. Concretely, it is provided with an analog interface module 30 and a plasma display panel module 40 (hereinafter, referred to as a PDP module). The analog interface module 30 converts received analog image signals into digital image signals, and then supplies the digital image signals to the PDP module 40.

The PDP module 40 puts on or off the respective PDP cells of the PDP 100, in accordance with the digital image signals sent from the analog interface module 30, and then displays desired images.

A method of driving the AC type PDP of the conventional memory operation type will be described below with reference to the drawings.

FIG. 6 is a timing chart showing a drive voltage waveform applied to each electrode of the conventional color PDP, which is the AC type PDP of the conventional memory operation type. In the method of driving, firstly, a fist priming discharge pulse 11a is applied to the sustaining electrode 4, and a second priming discharge pulse 11b is applied to the scanning electrode 3. The fist priming discharge pulse 11a is negative to a sustaining electrode standard potential. The second priming discharge pulse 11b is positive to a scanning electrode standard potential. A potential difference exceeding a discharge start voltage is given between the sustaining electrode 4 and the scanning electrode 3 so that all of the cells are forcedly discharged.

The first priming discharge pulse 11a has the shape of a rectangular wave in which a voltage is sharply changed in front and back edges. The second priming discharge pulse 11b has the shape of an inclined wave in which a front edge is gently changed. The change rate of the front edge is set to be smaller than about 10 (V/μs(microsecond)). After that, a priming erasing discharge pulse 12 is applied to the scanning electrode 3, and all of the cells are again forcedly discharged. The priming erasing discharge pulse 12 is negative to the scanning electrode standard potential. The priming erasing discharge pulse 12 has the shape of the inclined wave in which the front edge is gently changed. The change rate of the front edge is set to be smaller than about 10 (V/μs(microsecond)).

The discharging operation through the priming discharge pulse is referred to as a priming discharge. The discharging operation through the priming erasing discharge pulse is referred to as a priming erasing discharge. The priming erasing discharge has a function of adjusting a wall charge distribution, such that an erroneous discharge is prevented by a subsequent different drive pulse application. Also, the priming discharge and priming erasing discharge increase densities of active particles such as ions and molecules within the PDP cell and improve the reaction velocity of the generation of the subsequent data-writing discharge.

After the priming discharge and the priming erasing discharge, a scanning pulse 13 is applied to the scanning electrodes S1 to Sm at the timings which are respectively shifted. The scanning pulse 13 is negative to the scanning electrode standard potential. Matching the timing of the application of the scanning pulse 13, a data pulse 14 is applied to data electrodes D₁ to Dₙ, on the basis of display data. The data pulse 14 is positive to the data electrode standard potential. The oblique line of the data pulse 14 in FIG. 6 indicates that the presence or absence of the data pulse 14 is determined, in accordance with the presence or absence of the display data with regard to the corresponding PDP cell. At the time of the application of the scanning pulse 13, the discharge is generated in the discharge space 9 between the scanning electrode 3 and the data electrode 8 in the cell to which the data pulse 14 is applied. However, at the time of the application of the scanning pulse 13, the discharge is not generated if the data pulse 14 is not applied. In accordance with the presence or absence of this discharge, the display data is written to each PDP cell. Thus, this is referred to as a data-writing discharge.

Also, in the data-writing discharge of the above-mentioned configuration, with the discharge between the scanning electrode 3 and the sustaining electrode 4 as the trigger, the discharge between the scanning electrode 3 and the sustaining electrode 4 may be induced. In order to generate stably stably this discharge between the scanning electrode 3 and the sustaining electrode 4, there may be a following case. The case is to apply a bias potential (a sub-scanning pulse 17) to the sustaining electrode 4 for increasing the potential difference (the display gap potential difference) between the scanning electrode 3 and the sustaining electrode 4 at the time of the data-writing discharge. The sub-scanning pulse 17 is positive to the sustaining electrode standard potential. Also, in order to reduce the amplitude of the scanning pulse 13, there may be a following case. The case is to apply a bias potential (a scanning base pulse 18) to the scanning electrode, in the substantially entire range of the scanning period, and to apply only the amount corresponding to the change as the scanning pulse. The scanning base pulse 18 is negative to the scanning electrode standard potential.

In order to induce the discharge between the scanning electrode 3 and the sustaining electrode 4, with the discharge between the scanning electrode 3 and the sustaining electrode 4 as the trigger, it is necessary to adjust the potential difference between the scanning electrode 3 and the sustaining electrode 4. That is, the potential difference should be equal to or higher than the first threshold and equal to or lower than the second threshold, not to operate erroneously. At the first threshold, the discharge is generated in the scanning electrode 3 and the sustaining electrode 4 when the discharge is generated between the scanning electrode 3 and the data electrode 8. At the second threshold, the discharge is generated in the scanning electrode 3 and the sustaining electrode 4 when the discharge is not generated between the scanning electrode 3 and the data electrode 8.

In the cell in which the data-writing discharge is generated, positive charges referred to as wall charges are accumulated in the transparent dielectric layer 5a on the scanning electrode 3. At this time, the negative wall charges are accumulated in the white dielectric layer 5b on the data electrode 8. After that, the first discharge is generated by the overlap of the positive potential through the positive wall charges produced in the transparent dielectric layer 5a on the scanning electrode 3 and a first sustaining pulse 15a which is negative and applied to the sustaining electrode 4. Also, if the discharge between the scanning electrode 3 and the sustaining electrode 4 is induced at the time of the data-writing discharge, the negative wall charges are produced in the transparent dielectric layer 5a on the sustaining electrode 4 by the data-writing discharge. Thus, in the first sustaining pulse, the positive potential through the positive wall charges produced in the transparent dielectric layer 5a on the scanning electrode 3 and the negative potential through the negative wall charges produced in the transparent dielectric layer 5a on the sustaining electrode 4 are overlapped, and a first discharge is generated.

When the first discharge is generated, the positive wall charges are accumulated in the transparent dielectric layer 5a on the sustaining electrode 4, and the negative wall charges are accumulated in the transparent dielectric layer 5a on the scanning electrode 3. A second sustaining pulse 15b to be applied to the scanning electrode 3 is overlapped with the potential difference caused by those wall charges, and a second discharge is generated.

Hereafter, similarly, the potential difference caused by the wall charges produced at an n-th discharge and an (n+1)-th sustaining pulse are overlapped, and the discharge is sustained. For this reason, this discharging operation is referred to as a sustaining discharge. The value of brightness is controlled in accordance with the number of the maintenance of the sustaining discharge.

If the voltages of the sustaining pulses 15a, 15b are preliminarily adjusted to the degree that the discharge is not generated only by the application of those pulses, the first sustaining discharge is not generated even though the first sustaining pulse 15a is applied. Because the potential through the wall charges does not exist in the cell in which the data-writing discharge is not generated, before the application of the first sustaining pulse 15a. Hence, the sustaining discharge after that is not generated.

After the applications of the sustaining pulses 15a, 15b, a data-erasing pulse 16 which is negative to the scanning electrode standard potential is applied to all of the scanning electrodes 3. This causes that the discharge is generated in the cell in which the sustaining discharge continues, and the wall charge distribution is initialized. The data-erasing pulse 16 has the shape of an inclined wave in which a front edge is gently changed. A change rate of the front edge is set to be smaller than about 10 (V/μs(microsecond)). The discharging operation through the data-erasing pulse is referred to as a data-erasing discharge.

In the drive voltage waveform of FIG. 6 as mentioned above, the period in which the priming discharge pulses 11a, 11b and the priming erasing discharge pulse 12 are applied is referred to as a priming discharge period. The period in which the scanning pulse 13 and the data pulse 14 (in some cases, the sub-scanning pulse 17 and the scanning base pulse 18) are applied is referred to as a scanning period. The period in which the sustaining pulses 15a, 15b are applied is referred to as a sustaining period. The period in which the data-erasing pulse 16 is applied is referred as a data-erasing period. The PDP has the priming discharge period, the scanning period, the sustaining period and the data-erasing period, in one field implying the period to display one screen (for example, 1/60 seconds). If the one field is distributed into a plurality of subfields (for example, 4 subfields) to display one screen, each of the subfields has the priming discharge period, the scanning period, the sustaining period and the data-erasing period.

A gradation displaying method in the conventional PDP is described with reference to FIG. 7. FIG. 7 is a schematic view showing the relation between the field and subfields. The PDP has the priming discharge period, the scanning period, the sustaining period and the data-erasing period, in one field implying the period to display one screen (for example, 1/60 seconds) . If the one field is distributed into the plurality of subfields (for example, 4 subfields) to display the one screen, each of the subfields has the priming discharge period, the scanning period, the sustaining period and the data-erasing period.

The individual subfield is configured, for example, as shown in FIG. 6. In each subfield, the ON/OFF action of the display is controlled independently of the other subfields. Also, each subfield is different in the length of the sustaining period, in other words, different in the number of the sustaining pulses. Thus, the brightness is also different. In the 4-subfield distribution shown in FIG. 7, if the adjustment is done such that the ratio of the brightness when light is singly emitted of each subfield is 1:2:4:8, the brightness displays 16 stages from the brightness ratio 0 to 15 based on the combination of the display ON/OFF of the 4-subfields. The brightness ratio 0 is in a case that no subfield is selected. The brightness ratio 15 is in a case that all subfield is selected. Typically, when one field is distributed into n subfields and the ratio of the brightness for each subfield is set at 1 (=2⁰):2 (=2¹): . . . :2ⁿ⁻²:2ⁿ⁻¹, the 2ⁿ-gradation display becomes possible.

In the method of driving the conventional PDP as mentioned above, the priming discharge and the priming erasing discharge are generated in all of the cells and all of the subfields. Even in the case of the brightness 0 of the all-subfield selection, the light emission through the priming discharge and priming erasing discharge causes the brightness of several cd/m² (black brightness). In particular, if an image is watched in a dark room or the like, the contrast ratio drop caused by this black brightness may become extreme.

In conjunction with the above description, Japanese Laid Open Patent Application (JP-A-Heisei 8-221036) discloses a following technique. The technique is for increasing the contrast ratio by partially omitting the priming discharge. In the technique, the priming discharge operation is generated in only a part of the subfields or only a part of the cells. However, the partial omission of the priming discharge causes the reduction in the function of improving the discharging activity given by the priming discharge. Thus, the generation of the data-writing discharge becomes unstable, which does not generate the data-writing discharge and does not generate the sustaining discharge. There may be the case that the normal image display is impossible.

In conjunction with the above description, Japanese Laid Open Patent Application (JP-A-Heisei 8-96714) discloses a following technique. The technique is for placing a priming electrode (spare discharging electrode) between the cells, generating the priming discharge (spare discharge) between the scanning electrode or the sustaining electrode and the priming electrode, and generating the data-writing discharge, the sustaining discharge and the data-erasing discharge between the scanning electrode and the sustaining electrode. Since the priming discharge light emission is partially optically shielded, the black brightness is dropped to improve the contrast ratio. When the cell in which the priming electrode was placed was driven by using the above-mentioned driving method, the display of a static picture could be substantially controlled without any trouble. However, the display of a motion picture was unstable. Here, the unstableness of the motion picture display was the trouble of the operation, that the data-writing discharge was not generated or that even if the data-writing discharge was generated, it did not shift to the sustaining discharge, in the case that the light was selectively emitted from the cell in the state of black display for a long time (for several seconds).

FIGS. 8, 9 are used to explain the generation portion of the discharge in the conventional technique. FIG. 8 is a view showing the conventional driving method of the PDP having no priming discharge electrode. In the PDP having no priming discharge electrode, the priming discharge, the priming erasing discharge, the data-writing discharge, sustaining discharge and the data-erasing discharge are all generated in display gap. The data-writing discharge is generated between the scanning electrode and the data electrode. Just after that, since the discharge is induced between the scanning electrode and the sustaining electrode (the display gap), the generation position of the data-writing discharge is regarded as the display gap. Therefore, the display gap is defined as the generation position of the data-writing discharge. At the time of the generation of the data-writing discharge, if the potential difference of the display gap is made larger than a threshold, the data-writing discharge is generated in the display gap. If the potential difference of the priming discharge gap is made greater than a threshold, the data-writing discharge is generated in the priming discharge gap. If the potential differences of both of the gaps are made larger than a threshold, the data-writing discharge is generated in both of the gaps.

FIG. 9 is a view showing the conventional driving method of the PDP having the priming discharge electrode. In the PDP having the priming discharge electrode, the priming discharge and the priming erasing discharge are generated in the display gap. The data-writing discharge, the sustaining discharge and the data-erasing discharge are generated in the display gap. The operation trouble after the black display for the long time (more than several seconds) is generated in the conventional driving method of the PDP having the priming discharge electrode. The reason is that the discharge activity of the display gap can not be made sufficiently high, at the active particle density supplied by the priming discharge generated in the priming discharge gap, if the discharge in the display gap is not generated for the long time. Also, this is caused by the following fact. The charged particles, such as electrons, ions and the like are generated in the priming discharge generated in the priming discharge gap, the priming erasing discharge, or the respective discharges of the adjacent cells, while the discharge is not generated in the display gap for the long time. The charged particles gradually reduce the wall charge amount on the scanning electrode 3 and the sustaining electrode 4. That brings about the wall charge distribution unsuitable for the generation of the data-writing discharge and sustaining discharge after the long time.

The PDP is desired in which the further stable image display is possible and the contrast ratio is further increased.

The PDP is desired in which the still image can be excellently displayed and even the motion image can be excellently displayed such that the light is selectively emitted from the cell in the state of the black display for the long time (several seconds).

### SUMMARY OF THE INVENTION

Therefore, an object of the present invention is to provide a plasma display apparatus and a method of driving a PDP, which can increase a contrast ratio in a PDP including a priming discharge electrode.

Another object of the present invention is to provide a plasma display apparatus and a method of driving a PDP, which can excellently display a still image at a stable operation and excellently display a stable motion image in a PDP including a priming discharge electrode.

Still another object of the present invention is to provide a plasma display apparatus and a method of driving a PDP, which can improve displaying properties in a PDP including a priming discharge electrode.

This and other objects, features and advantages of the present invention will be readily ascertained by referring to the following description and drawings.

In order to achieve an aspect of the present invention, the present invention provides a plasma display apparatus including a plasma display panel and a driving control section which outputs drive control signals to drive the plasma display panel. The plasma display panel includes a front substrate and a rear substrate which is faced to the front substrate. Discharge spaces are formed between the front substrate and the rear substrate. The front substrate includes a plurality of sets of front electrodes, each of which is extended toward a first direction, and includes a scanning electrode, a sustaining electrode and a priming discharge electrode. One of a gap between the scanning electrode and the priming electrode and a gap between the sustaining electrode and the priming electrode is formed as a priming discharge gap where a discharge is generated. A gap between the scanning electrode and the sustaining electrode is formed as a display gap where a discharge is generated. The rear substrate includes a plurality of data electrodes which extends toward a second direction. The drive control signals include a first drive control signal. The first drive control signal indicates an operation of distributing a field into a plurality of subfields, generating a priming discharge in the priming discharge gap in the plurality of the subfields, and generating the priming discharge in the display gap in at least one of the plurality of the subfields. The plasma display panel is driven based on the first drive control signal.

In the plasma display apparatus according to the present invention, the priming discharge gap is the gap between the scanning electrode and the priming electrode. The first drive control signal includes a second drive control signal. The second drive control signal indicates an operation of generating a discharge in a gap between the scanning electrode and one of the plurality of the data electrode by applying a data pulse to the one data electrode synchronous to a scanning pulse applied to the scanning electrode, setting a potential difference of the priming discharge gap to be larger than the first threshold and smaller than the second threshold when the scanning pulse is applied, generating a sustaining discharge after discharging in the gap between the scanning electrode and the one data electrode while generating at least a first sustaining discharge in the priming discharge gap. The first threshold is that a discharge is generated in the priming discharge gap when a discharge is generated between the scanning electrode and the one data electrode. The second threshold is that a discharge is generated in the priming discharge gap when a discharge is not generated between the scanning electrode and the one data electrode.

In the plasma display apparatus according to the present invention, the first drive control signal includes a third drive control signal. The third drive control signal indicates an operation of generating at least the first sustaining discharge in the priming discharge gap, generating other sustaining discharge in the displaying gap, and generating a data-erasing discharge in the priming discharge gap and the displaying gap, the data-erasing discharge initializes a distribution of charges in the discharge space.

In the plasma display apparatus according to the present invention, the first drive control signal includes a fourth drive control signal. The fourth drive control signal indicates an operation of generating the sustaining discharge including a first sustaining discharge in the display gap, and generating a data-erasing discharge in the priming discharge gap and the displaying gap, the data-erasing discharge initializes a distribution of charges in the discharge space.

In the plasma display apparatus according to the present invention, the first drive control signal includes a fifth drive control signal. The fifth drive control signal indicates an operation of generating the data-erasing discharge in the priming discharge gap and the displaying gap simultaneously.

In the plasma display apparatus according to the present invention, the first drive control signal includes a sixth drive control signal. The sixth drive control signal indicates an operation of setting a potential difference of the display gap to be larger than the third threshold and smaller than the fourth threshold when the scanning pulse is applied. The third threshold is that a discharge is generated in the display gap when a discharge is generated between the scanning electrode and the one data electrode. The fourth threshold is that a discharge is generated in the display gap when a discharge is not generated between the scanning electrode and the one data electrode.

In the plasma display apparatus according to the present invention, the first drive control signal includes a seventh drive control signal. The seventh drive control signal indicates an operation of generating the priming discharge in the priming discharge gap in each of the plurality of the subfields.

In the plasma display apparatus according to the present invention, the first drive control signal includes a eighth drive control signal. The eighth drive control signal indicates an operation of generating the priming discharge only in the display gap in at least one of the plurality of the subfields.

In the plasma display apparatus according to the present invention, the first drive control signal includes a ninth drive control signal. The ninth drive control signal indicates an operation of generating the priming discharge only in the priming discharge gap in at least one of the plurality of the subfields, and generating the priming discharge only in the display gap in remaining of the plurality of the subfields.

In the plasma display apparatus according to the present invention, the driving control section includes a history detecting section which detects a history data of generating of display discharges in the display gap, and judges whether or not the priming discharge is generated in the displaying gap based on the history data.

In the plasma display apparatus according to the present invention, the history data includes a number of light-emitting of cells in at least one of a predetermined area and a predetermined time period.

In order to achieve another aspect of the present invention, the present invention provides a driving method of a plasma display panel included in a plasma display apparatus. The plasma display apparatus includes the plasma display panel and a driving control section which outputs drive control signals to drive the plasma display panel. The plasma display panel includes a front substrate and a rear substrate which is faced to the front substrate. A discharge space is formed between the front substrate and the rear substrate. The front substrate includes a plurality of sets of front electrodes, each of which is extended toward a first direction, and includes a scanning electrode, a sustaining electrode and a priming discharge electrode. One of a gap between the scanning electrode and the priming electrode and a gap between the sustaining electrode and the priming electrode is formed as a priming discharge gap where a discharge is generated. A gap between the scanning electrode and the sustaining electrode is formed as a display gap where a discharge is generated. The rear substrate includes a plurality of data electrodes which extends toward a second direction. The method includes (a) distributing a field into a plurality of subfields; (b) generating a priming discharge in the priming discharge gap in the plurality of the subfields; and (c) generating the priming discharge in the display gap in at least one of the plurality of the subfields.

The driving method of a plasma display panel that the priming discharge gap is the gap between the scanning electrode and the priming electrode, according to the present invention, further includes (d) generating a discharge in a gap between the scanning electrode and one of the plurality of the data electrode by applying a data pulse to the one data electrode synchronous to a scanning pulse applied to the scanning electrode; and (e) generating a sustaining discharge after discharging in the gap between the scanning electrode and the one data electrode while generating at least a first sustaining discharge in the priming discharge gap. A potential difference of the priming discharge gap is larger than the first threshold and smaller than the second threshold when the scanning pulse is applied. The first threshold is that a discharge is generated in the priming discharge gap when a discharge is generated between the scanning electrode and the one data electrode. The second threshold is that a discharge is generated in the priming discharge gap when a discharge is not generated between the scanning electrode and the one data electrode.

The driving method of a plasma display panel according to the present invention, further includes (f) generating a data-erasing discharge in the priming discharge gap and the displaying gap. The data-erasing discharge initializes a distribution of charges in the discharge space. The step (e) includes (e1) generating at least the first sustaining discharge in the priming discharge gap, and (e2) generating other sustaining discharge in the displaying gap.

The driving method of a plasma display panel according to the present invention, further includes (f) generating a data-erasing discharge in the priming discharge gap and the displaying gap. The data-erasing discharge initializes a distribution of charges in the discharge space. The step (e) includes (e3) generating the sustaining discharge including a first sustaining discharge in the display gap.

In the driving method of a plasma display panel according to the present invention, the step (f) includes (f1) generating the data-erasing discharge in the priming discharge gap and the displaying gap simultaneously.

In the driving method of a plasma display panel according to the present invention, a potential difference of the display gap is set to be larger than the third threshold and smaller than the fourth threshold when the scanning pulse is applied. The third threshold is that a discharge is generated in the display gap when a discharge is generated between the scanning electrode and the one data electrode. The fourth threshold is that a discharge is generated in the display gap when a discharge is not generated between the scanning electrode and the one data electrode.

In the driving method of a plasma display panel according to the present invention, the step (b) includes (b1) generating the priming discharge in the priming discharge gap in each of the plurality of the subfields.

In the driving method of a plasma display panel according to the present invention, the step (c) includes (c1) generating the priming discharge in the display gap in each of the plurality of the subfields.

In the driving method of a plasma display panel according to the present invention, the step (c) includes (c2) generating the priming discharge in the display gap in one of the plurality of the subfields.

In the driving method of a plasma display panel according to the present invention, the step (b) includes (b1) generating the priming discharge only in the priming discharge gap in at least one of the plurality of the subfields. The step (c) includes (c3) generating the priming discharge only in the display gap in remaining of the plurality of the subfields.

The driving method of a plasma display panel according to the present invention, further includes (g) detecting a history data of generating of display discharges in the display gap, and (h) judging whether or not the priming discharge is generated in the displaying gap based on the history data.

In the driving method of a plasma display panel according to the present invention, the history data includes a number of light-emitting of cells in at least one of a predetermined area and a predetermined time period.

In order to achieve still another aspect of the present invention, the present invention provides a plasma display apparatus which includes a front substrate and a rear substrate faced to the front substrate. A plurality of discharge spaces is formed between the front substrate and the rear substrate. A priming discharge gap and a display discharge gap are formed in each of the plurality of discharge spaces. One field is distributed into a plurality of subfields for displaying image data. The plasma display apparatus is characterized in that a priming discharge is generated in the display discharge gap in at least one of another plurality of the subfields.

A plasma display apparatus of the present invention, which includes a front substrate and a rear substrate faced to the front substrate. A plurality of discharge spaces is formed between the front substrate and the rear substrate. A display discharge gap and a priming discharge gap corresponding to the display discharge gap are formed in each of the plurality of discharge spaces. One field is distributed into a plurality of subfields for displaying image data. The plasma display apparatus is characterized in that a priming discharge generated in the display discharge gap is controlled based on a history of display discharges generated in the display discharge gap.

### BRIEF DESCRIPTION OF THE DRAWINGS

FIG. 1 is a projection view showing the configuration of the AC type PDP;

FIG. 2 is a view showing a section of a PDP cell formed on the conventional PDP;

FIG. 3 is a plan view from the displaying direction of the conventional PDP;

FIG. 4 is a plan view of the electrode structure of the color PDP;

FIG. 5 is a block diagram showing the configuration of the plasma display apparatus;

FIG. 6 is a timing chart showing a drive voltage waveform applied to each electrode of the conventional color PDP;

FIG. 7 is a schematic view showing the relation between the field and subfields;

FIG. 8 is a view showing the conventional driving method of the PDP having no priming discharge electrode;

FIG. 9 is a view showing the conventional driving method of the PDP having the priming discharge electrode;

FIG. 10 is a sectional view of a PDP cell in the embodiment;

FIG. 11 is a plan view of the PDP cell in the embodiment;

FIG. 12 is a block diagram showing the configuration of the plasma display apparatus;

FIG. 13 is a view showing the discharge generating portions in an operation of a first embodiment;

FIG. 14 is a flowchart showing an operation of the first embodiment;

FIGS. 15 and 16 are driving waveforms in the first embodiment of the present invention;

FIG. 17 is a sectional view of another PDP cell in the embodiment;

FIG. 18 is a plan view of the other PDP cell in the embodiment;

FIG. 19 is a view showing the discharge generation portion in the operation of a second embodiment;

FIG. 20 is a flowchart showing an operation of the second embodiment;

FIGS. 21 and 22 is driving waveforms of the second embodiment;

FIG. 23 is a view showing the discharge generation portion in the operation of a third embodiment;

FIG. 24 is a flowchart showing an operation of the third embodiment;

FIGS. 25 and 26 are driving waveforms of the third embodiment;

FIG. 27 is a view showing the discharge generation portion in a fourth embodiment;

FIG. 28 is a flowchart showing an operation of the fourth embodiment;

FIGS. 29 and 30 show the concrete driving waveforms of the fourth embodiment;

FIG. 31 is a view showing the discharge generation portion in a fifth embodiment;

FIG. 32 is a flowchart showing an operation of the fifth embodiment;

FIGS. 33 and 34 are driving waveforms of the fifth embodiment; and

FIG. 35 is a flowchart showing an operation of the sixth embodiment.

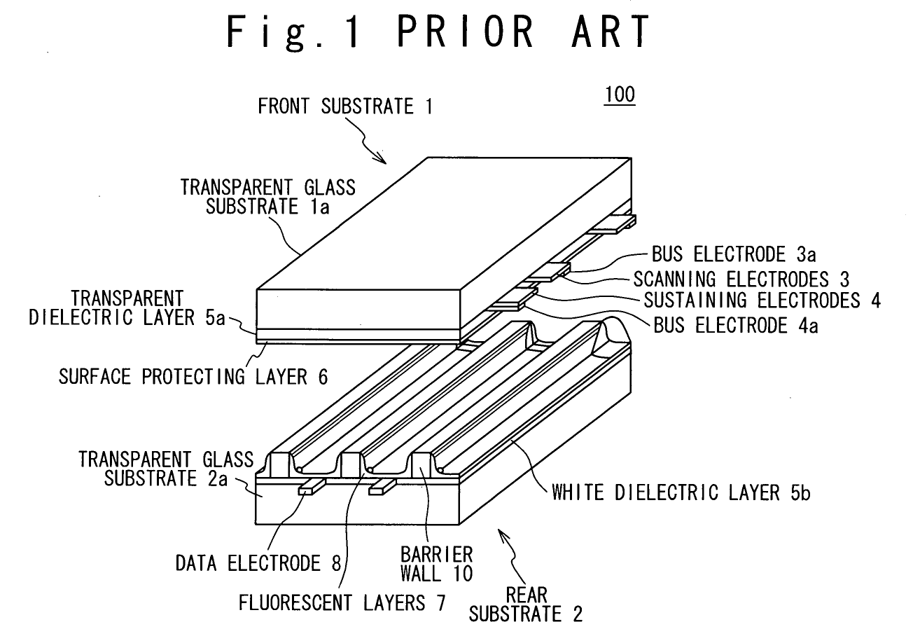

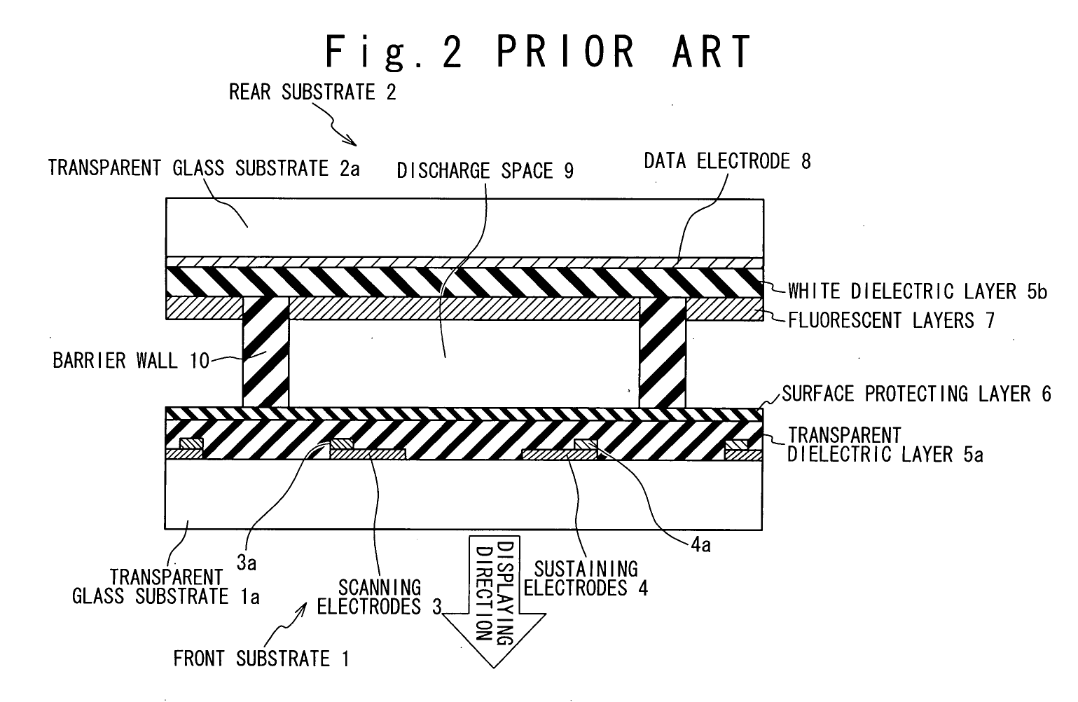

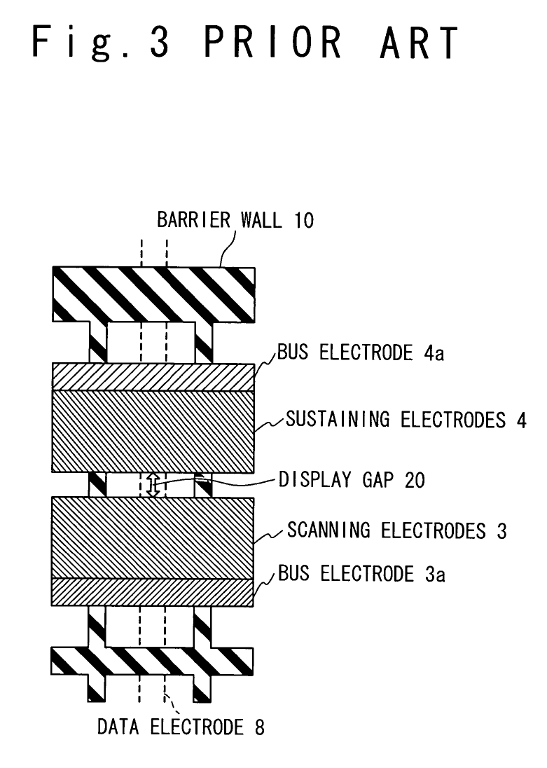

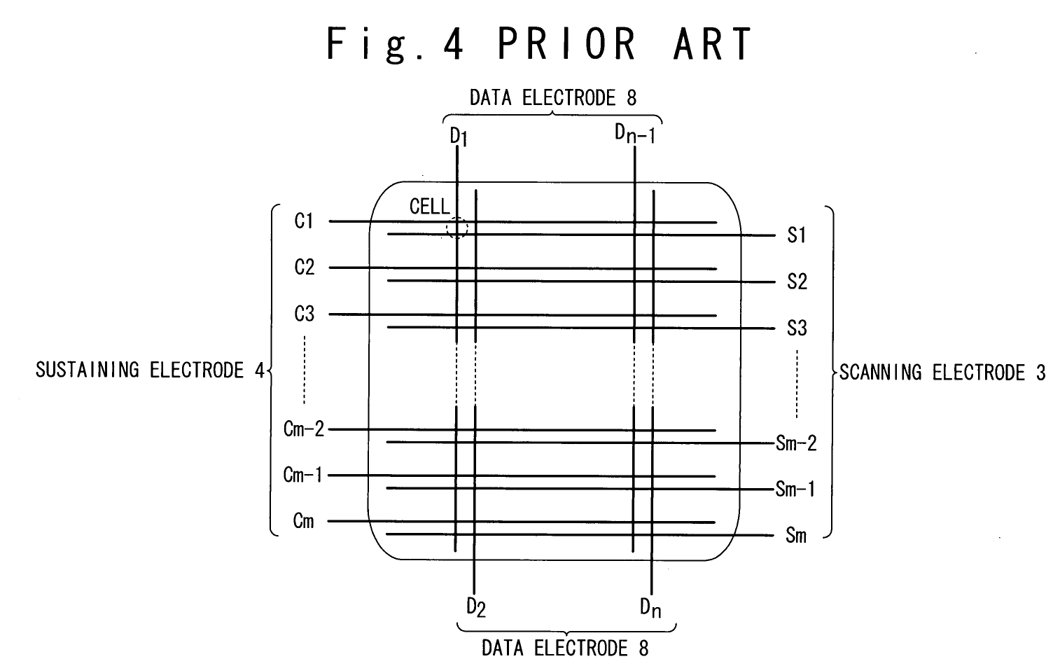

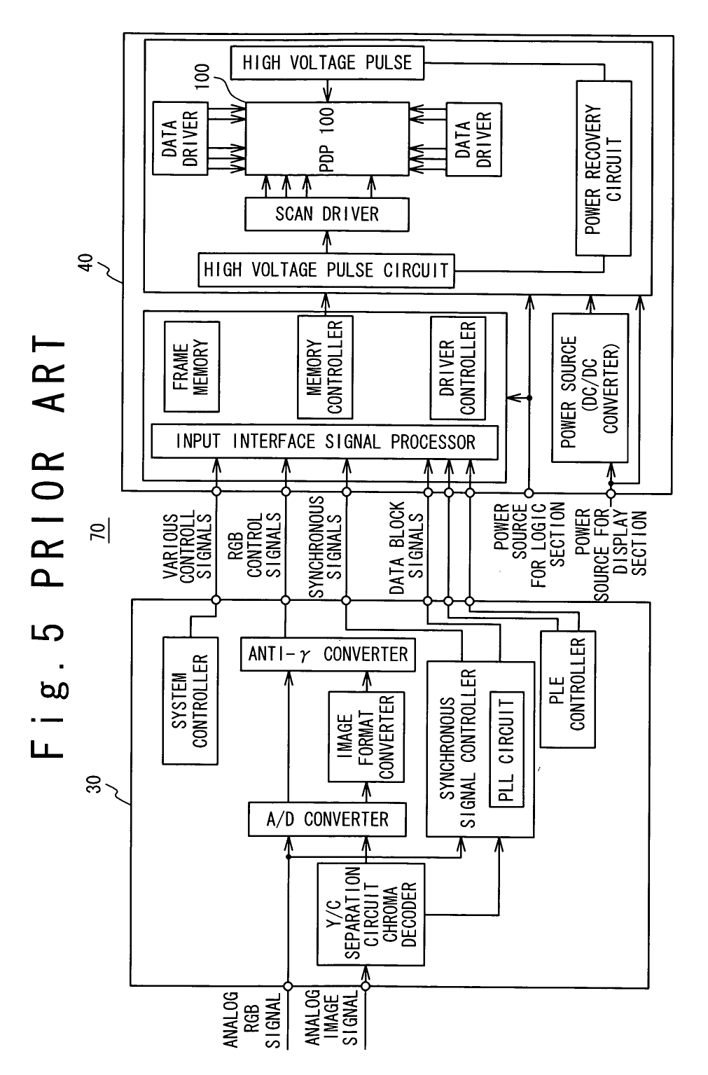

### DESCRIPTION OF THE PREFERRED EMBODIMENTS

Embodiments of a plasma display apparatus and a method of driving a PDP according to the present invention will be described below with reference to the attached drawings.

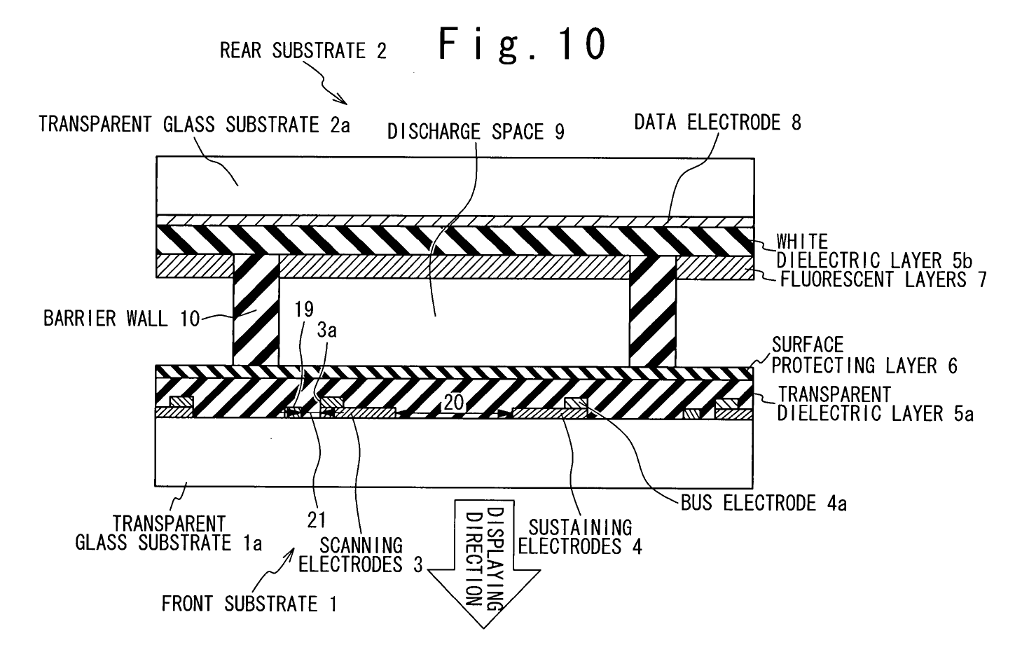

FIG. 10 is a sectional view of a PDP cell in the embodiment of the present invention. With reference to FIG. 10, a PDP is provided with a front substrate 1 and a rear substrate 2.

The front substrate 1 is composed of a transparent glass substrate 1a, a scanning electrode 3, a sustaining electrode 4, a priming discharge electrode 19, a bus electrode 3a, a bus electrode 4a, a transparent dielectric layer 5a and a surface protecting layer 6. The scanning electrode 3 is formed on and parallel to the transparent glass substrate 1a. The sustaining electrode 4 is formed on the transparent glass substrate 1a. The priming discharge electrode 19 is formed on the transparent glass substrate 1a. The bus electrode 3a is formed on the scanning electrode 3. The bus electrode 4a is formed on the sustaining electrode 4. The transparent dielectric layer 5a is formed on the transparent glass substrate 1a, for covering the scanning electrode 3, the sustaining electrode 4, the bus electrodes 3a, 4a and the priming discharge electrode 19. The surface protecting layer 6 covers the transparent dielectric layer 5a. The priming discharge electrode 19, the scanning electrode 3 and the sustaining electrode 4 are formed in parallel to each other.

The rear substrate 2 is composed of a transparent glass substrate 2a, a data electrode 8, a white dielectric layer 5b, a fluorescent layer 7 and a barrier wall 10. The data electrode 8 is formed on the transparent glass substrate 2a. The white dielectric layer 5b is formed on the transparent glass substrate 2a, for covering the data electrode 8. The barrier wall 10 is formed on the white dielectric layer 5b, for dividing displaying cells. The data electrode 8 is formed in the direction orthogonal to the scanning electrode 3 and the sustaining electrode 4. The fluorescent layer 7 is formed on the side of the barrier wall formed on the rear substrate 2 and the surface of the white dielectric layer 5b. The fluorescent layer 7 converts ultraviolet light, which is generated by gas discharge, into visible light.

For example, red (R), green (G) and blue (B) of the fluorescent layers 7 are distributed into cells (hereafter, referred to as a PDP cell) of the PDP. Red (R), green (G) and blue (B) are the three primary colors of light.

The front substrate 1 and the rear substrate 2 are fixed in the opposite situation in an interval of about 100 μm (micrometer). Its periphery is air-tightly sealed with adhesive. The space formed between the front substrate 1 and the rear substrate 2 defines a discharge space 9. The discharge gas composed of helium, neon, xenon or mixture gas of them is filled in this discharge space 9.

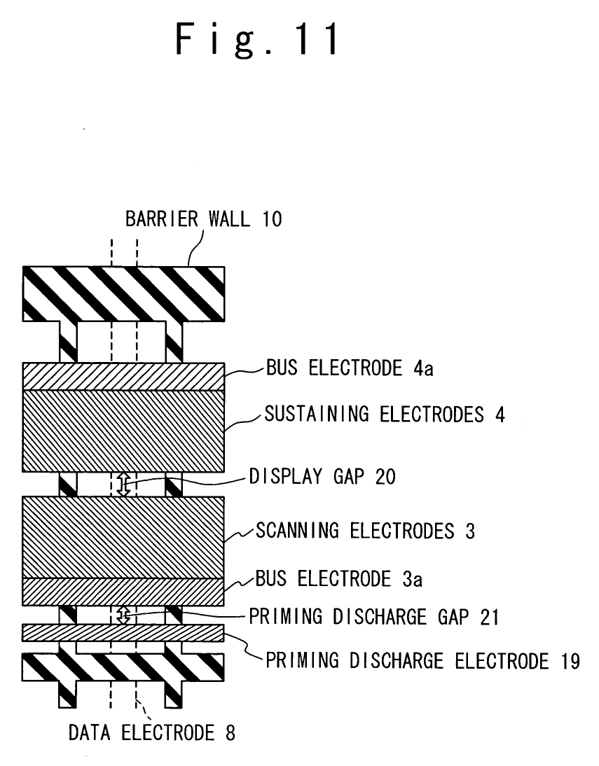

FIG. 11 is a plan view of the PDP cell in the embodiment of the present invention from the display direction. The scanning electrode 3, the sustaining electrode 4 and the priming discharge electrode 19 are formed at a predetermined interval on the transparent glass substrate 1a (not shown) in parallel to each other. The plurality of data electrodes 8 is formed at a predetermined interval each other on the transparent glass substrate 2a (not shown). They are formed orthogonally to the scanning electrode 3, the sustaining electrode 4 and the priming discharge electrode 19. The display gap 20 is the gap between the scanning electrode 3 and the sustaining electrode 4. The priming discharge gap 21 is the gap between the scanning electrode 3 and the priming discharge electrode 19.

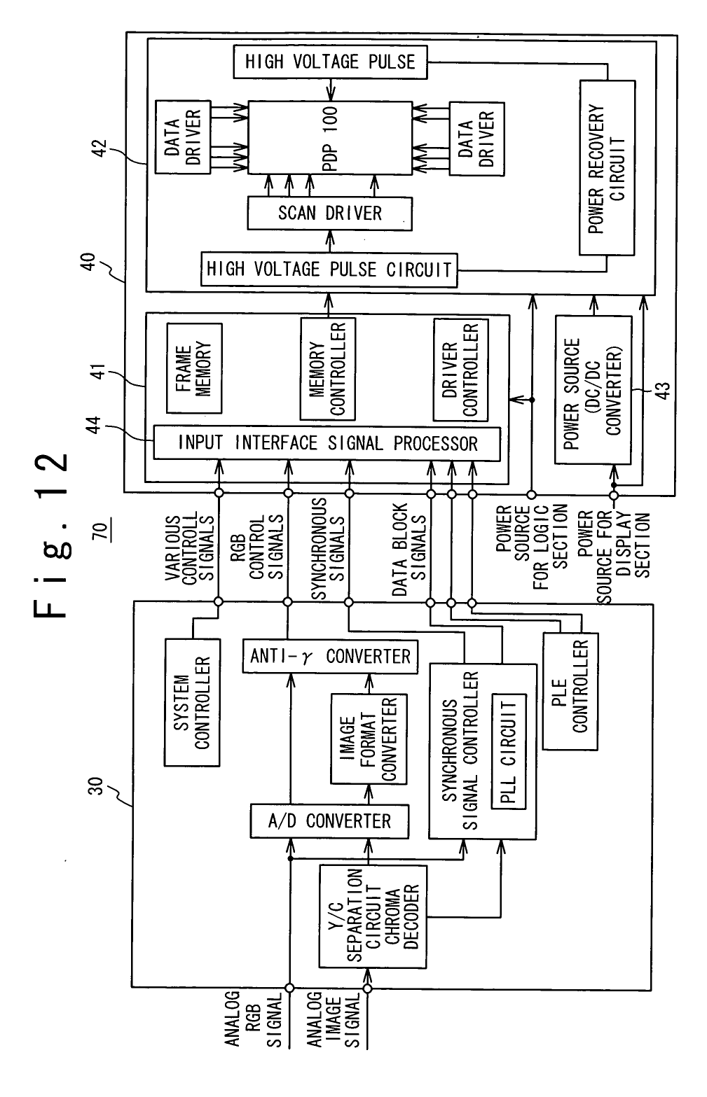

FIG. 12 is a block diagram showing the configuration of the plasma display apparatus manufactured by using the PDP in the embodiment of the present invention.

With reference to FIG. 12, a plasma display apparatus 70 has module structure. Concretely, it is provided with an analog interface module 30 and a PDP module 40. The analog interface module 30 converts received analog image signals into digital image signals, and then supplies the digital image signals to the PDP module 40.

The PDP module 40 is further composed of a drive control section 41, a panel section 42 and a power source section 43. The drive control section 41 outputs drive control signals for driving the PDP, to the panel section 42 including the PDP, in accordance with digital image signals sent from the analog interface module 30. The panel section 42 puts on or off the respective PDP cells of the PDP, in accordance with the drive control signals, and displays desired images on the PDP.

[Operation of Embodiment]

The displaying operation of the plasma display apparatus including the PDP described above will be described below with reference to the attached drawings. In particular, the discharge to be generated and the image to be displayed, in accordance with the outputted control signals from the drive control section 41 for driving the PDP, will be described in detail.

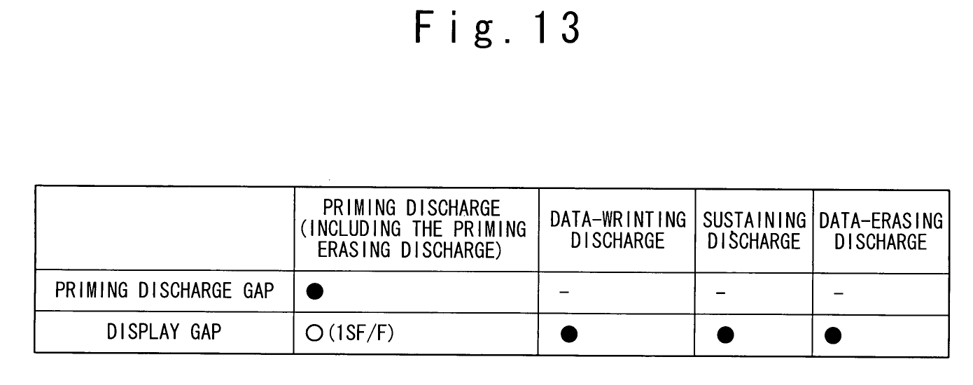

FIG. 13 is a view showing the discharge generating portions in an operation of a first embodiment of the present invention. The PDP have the priming discharge electrode 19, independently of the scanning electrode 3 and the sustaining electrode 4, at the position between adjacent cells. With respect to driving the PDP, in the priming discharge gap 21, the priming discharge and the priming erasing discharge are generated in all subfields. In the display gap 20, the data-writing discharge, the sustaining discharge and the data-erasing discharge are generated out in all subfields. Moreover, only in one subfield in one field, the priming discharge and the priming erasing discharge are generated in the display gap 20.

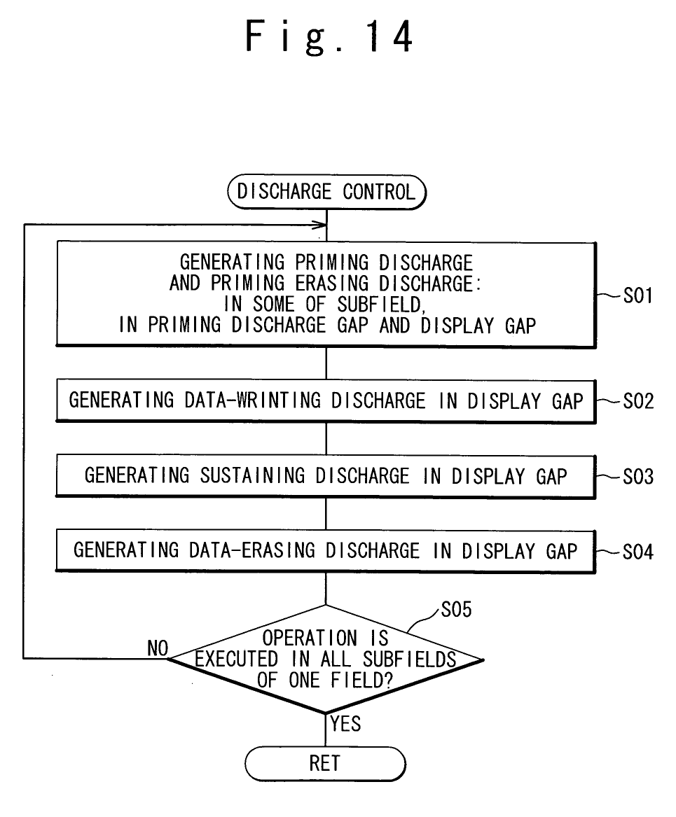

FIG. 14 is a flowchart showing an operation of the first embodiment according to the present invention. In this exemplified case, in the first subfield, the priming discharge and the priming erasing discharge are generated in the priming discharge gap 21 and the display gap 20. However, the present invention is not limited in the first subfield.

Firstly, in the first subfield, the priming discharge and the priming erasing discharge are generated in the priming discharge gap 21 and the display gap 20 (step S01). Next, the data-writing discharge is generated in the display gap 20 (step S02). Then, the sustaining discharge is generated in the display gap 20 (step S03). Next, the data-erasing discharge is generated in the display gap 20 (step S04). After that, as other subfields of one field remain (step S05: NO), the operation goes back to the step S01. On and after the second subfield, the priming discharge and the priming erasing discharge are generated in the priming discharge gap 21 (S01). Next, the data-writing discharge (S02), the sustaining discharge (S03), the data-erasing discharge (S04) are generated in the display gap 20. After that, if all subfields of one field are finished (S05: YES), the operation goes to the step S01 for a next field.

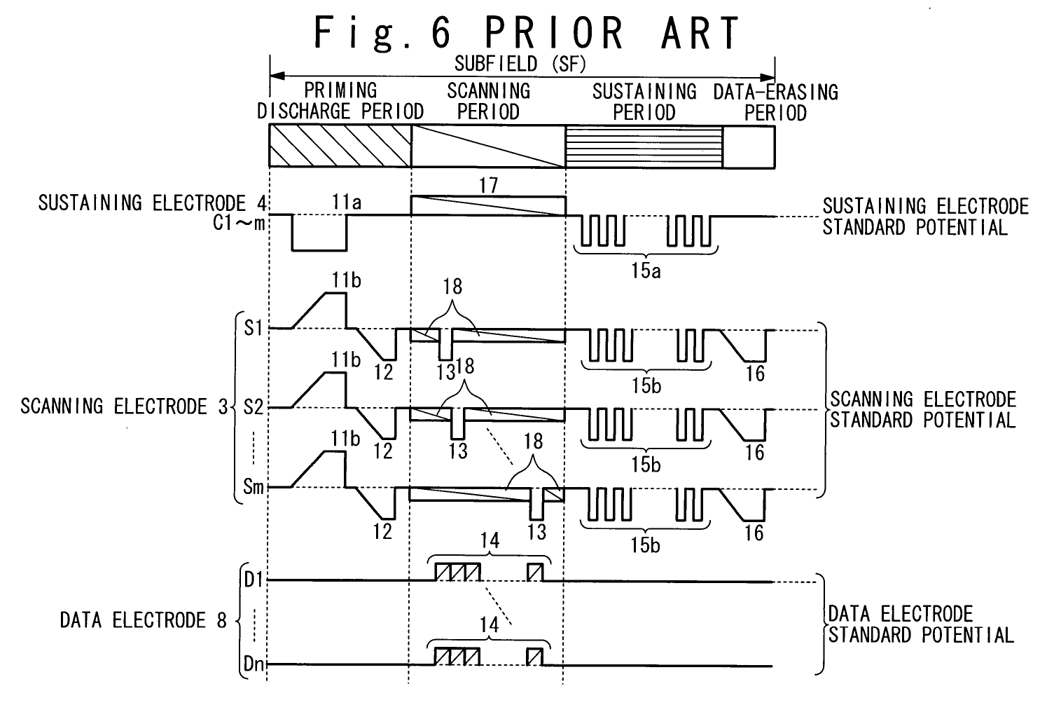

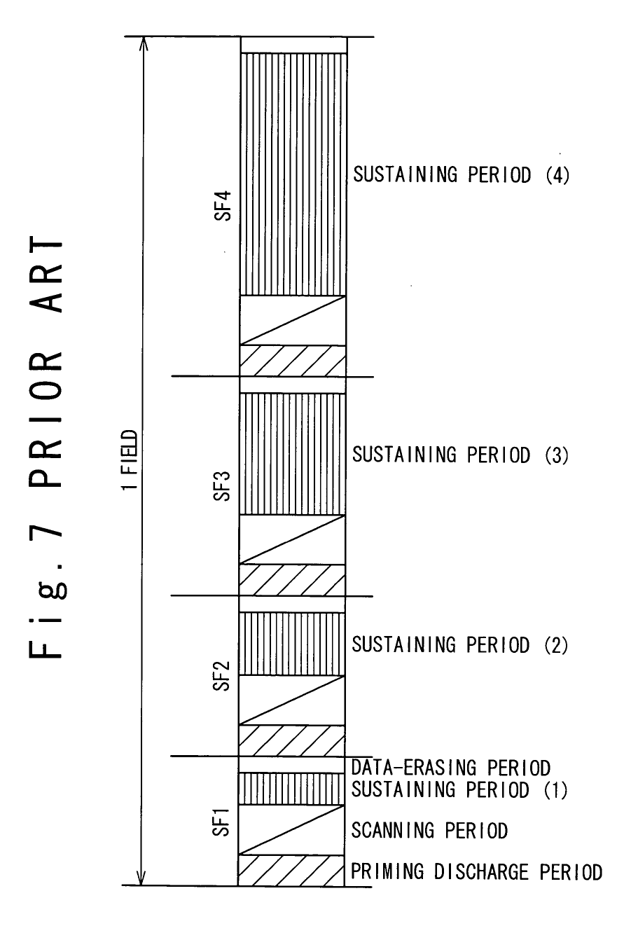

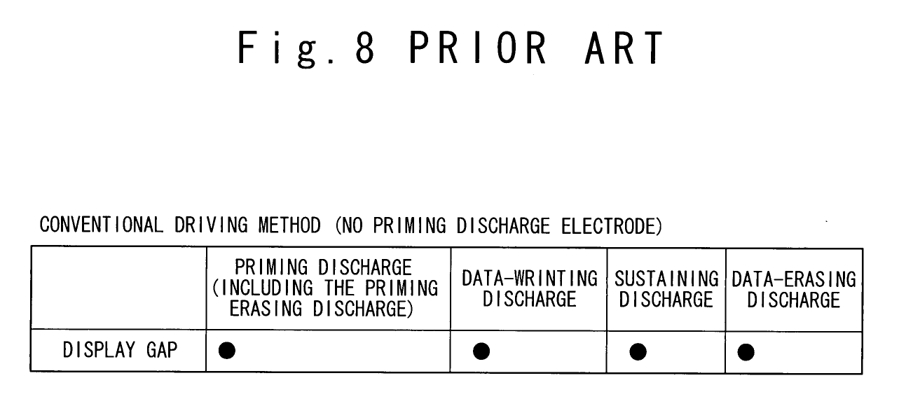

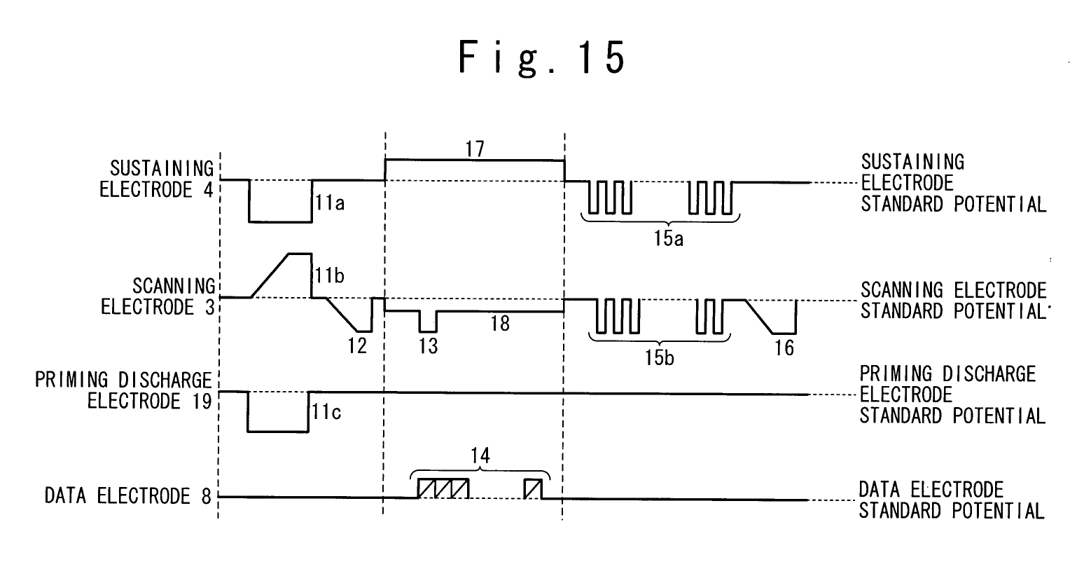

FIG. 15 is driving waveforms when the priming discharge is generated in both of the priming discharge gap and the display gap, in the first embodiment of the present invention. A priming discharge pulse 11a that is negative to a sustaining electrode standard potential is applied to the sustaining electrode 4. The priming discharge pulse 11b that is positive to a scanning electrode standard potential is applied to the scanning electrode 3. The priming discharge pulse 11c that is negative to a priming discharge electrode standard potential is applied to the priming discharge electrode 19. Then, the potential difference exceeding a discharge start voltage is given to the priming discharge gap 21 and the display gap 20, respectively, and the priming discharge is generated. After that, a priming erasing discharge pulse 12 that is negative to the scanning electrode standard potential is applied to the scanning electrode 3, and the priming erasing discharge is generated in both of the gaps(20,21). Other pulses for the operation are the same as those shown in FIG. 6.

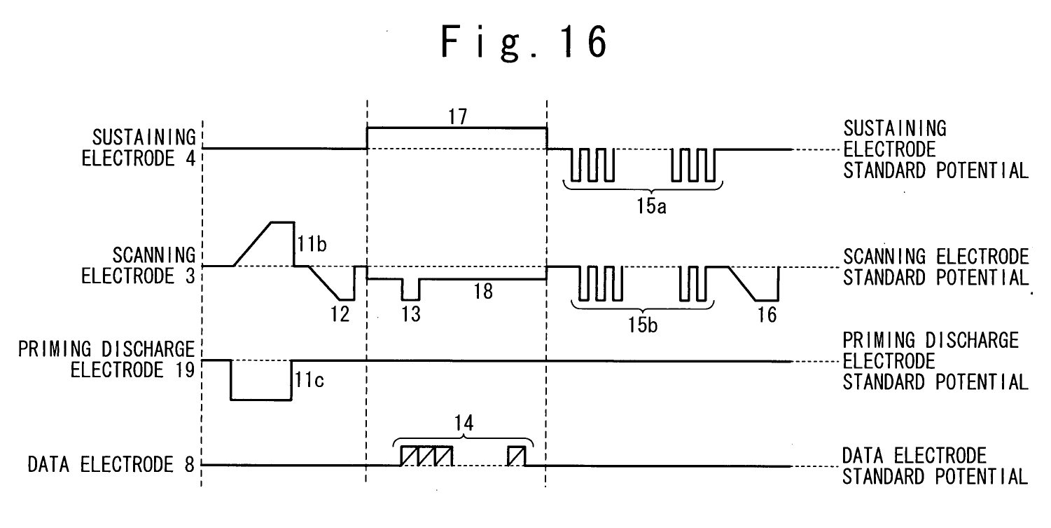

FIG. 16 is driving waveforms when the priming discharge is generated in the priming discharge gap 21, and the priming discharge is not generated in the display gap 20 in the first embodiment of the present invention. The priming discharge pulse 11c that is negative to the priming discharge electrode standard potential is applied to the priming discharge electrode 19. The potential difference exceeding the discharge start voltage is given to the priming discharge gap 21. Then, the priming discharge is generated. After that, the priming erasing discharge pulse 12 that is negative to the scanning electrode standard potential is applied to the scanning electrode 3, and the priming erasing discharge is generated in the priming discharge gap 21. Other pulses for the operation are the same as those shown in FIG. 15.

As shown in this embodiment, the priming discharge and the priming erasing discharge are generated in the display gap 20 in one subfield in one field, the discharge activity in the display gap 20 is made stronger, and the wall charge distribution is periodically initialized. That enables the adaptation to the motion image display. Concretely, the cell in the state of the black display for the long time can be suitably addressed, thereby shifting to the sustaining discharge.

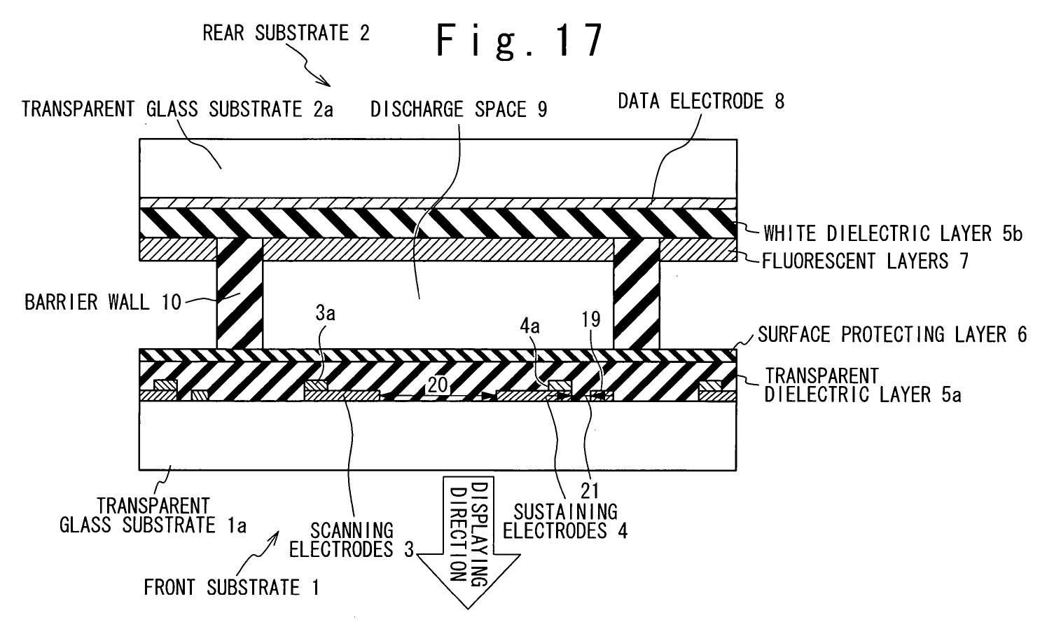

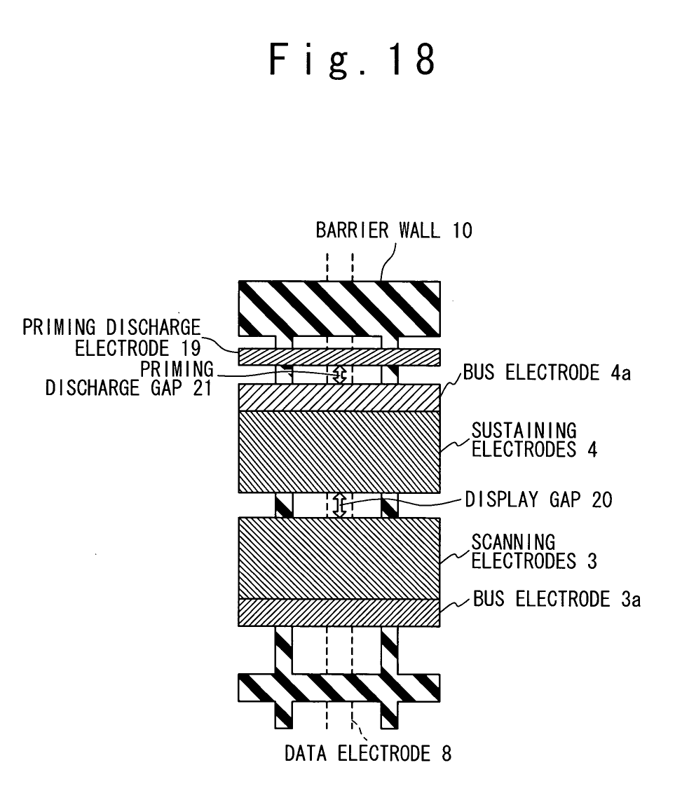

The unstableness in the data-writing discharge generation can be solved by using the driving method described in this embodiment of the driving the PDP. Moreover, FIGS. 10 and 11 show the configuration in which the priming discharge gap 21 is formed by using the scanning electrode 3 and the priming discharge electrode 19 formed beside the scanning electrode 3. However, this embodiment is not limited to it. The effect of the present invention is not changed even under the configuration in which the priming discharge gap 21 is formed by using the sustaining electrode 4 and the priming discharge electrode 19 formed beside the sustaining electrode 4, such as a configuration shown in FIGS. 17 and 18.

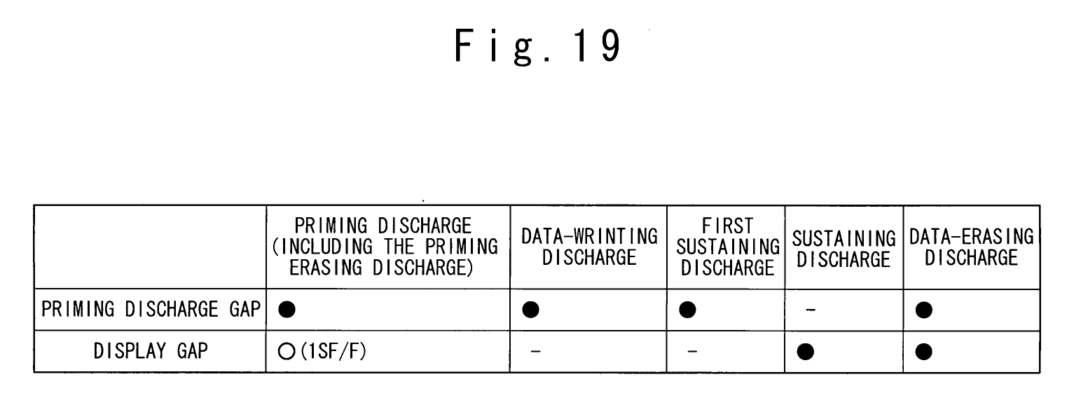

FIG. 19 is a view showing the discharge generation portion in the operation of a second embodiment of the present invention. The PDP has the same configuration as that of the first embodiment. With respect to driving the PDP, in the priming discharge gap 21, the priming discharge, the priming erasing discharge, the data-writing discharge, at least first sustaining discharge and the data-erasing discharge are generated in all of the subfields. In the display gap 20, the sustaining discharges except at least first sustaining discharge, and the data-erasing discharge are generated in all of the subfields. Moreover, only in one subfield in one field, the priming discharge and the priming erasing discharge are generated in the display gap 20. In this embodiment, the configuration is desired in which the priming discharge gap 21 is formed by using the priming discharge electrode 19 and the scanning electrode 3, in order to generate the data-writing discharge in the priming discharge gap 21.

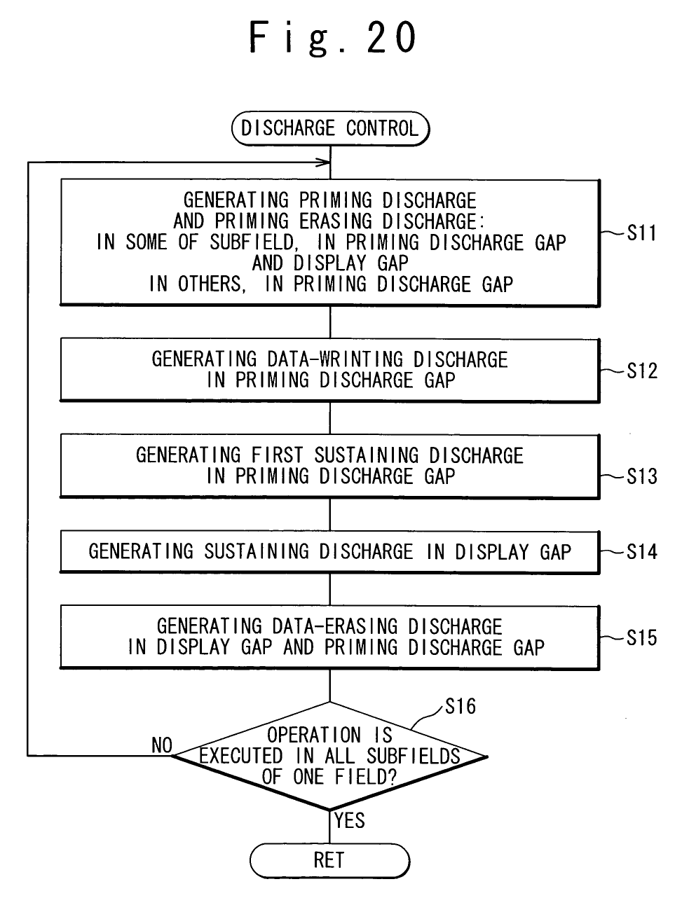

FIG. 20 is a flowchart showing an operation of the second embodiment according to the present invention. In this exemplified case, in the first subfield, the priming discharge and the priming erasing discharge are generated in the priming discharge gap 21 and the display gap 20. However, the present invention is not limited in the first subfield.

Firstly, in the first subfield, the priming discharge and the priming erasing discharge are generated in the priming discharge gap 21 and the display gap 20 (step S11). Next, the data-writing discharge is generated in priming discharge gap 21 (step S12). Then, the first sustaining discharge is generated in the priming discharge gap 21 (step S13). After that, the sustaining discharge is generated in the display gap 20 (step S14). Next, the data-erasing discharge is generated in the priming discharge gap 21 and the display gap 20 (step S15). After that, as other subfields of one field remain (step S16: NO), the operation goes back to the step S11. On and after the second subfield, the priming discharge and the priming erasing discharge (S11), the data-writing discharge (S12) and the first sustaining discharge (S13) are generated in the priming discharge gap 21. Next, the sustaining discharge (S14) is generated in the display gap 20. Then, the data-erasing discharge (S15) is generated in the priming discharge gap 21 and the display gap 20. After that, if all subfields of one field are finished (S16: YES), the operation goes to the step S11 for a next field.

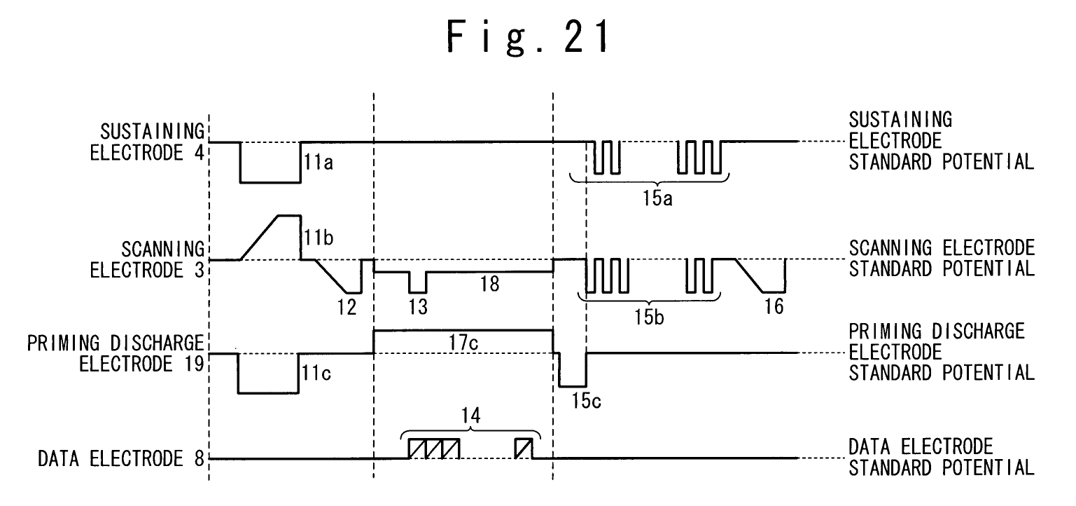

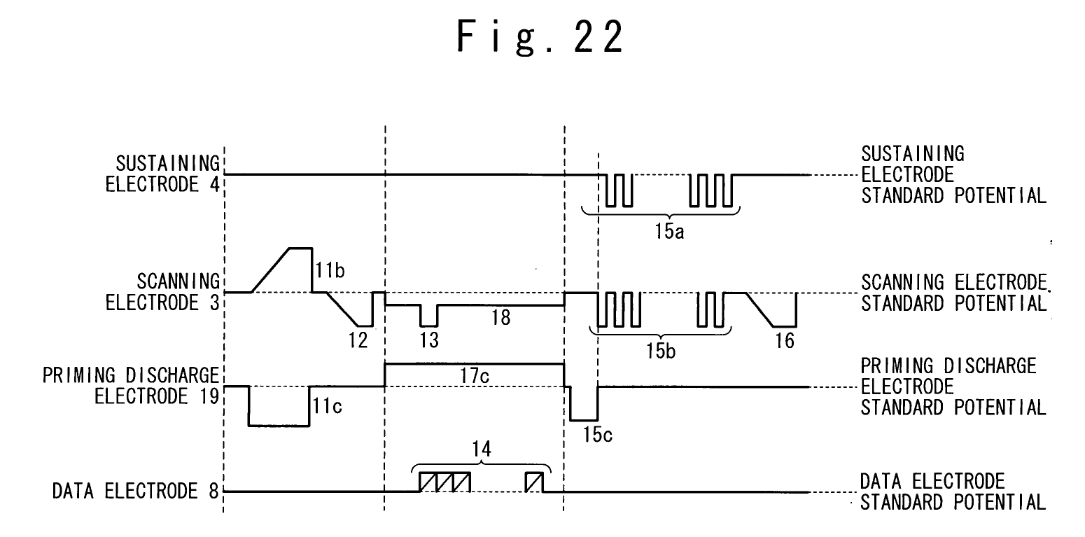

FIGS. 21 and 22 is driving waveforms when the discharge is generated in the discharge generation portion shown in FIG. 19 of the second embodiment. FIG. 21 is the driving waveform when the priming discharge is generated in both of the priming discharge gap 21 and the display gap 20. FIG. 22 is the driving waveform when the priming discharge is generated in the priming discharge gap 21, and the priming discharge is not generated in the display gap 20.

With reference to FIG. 21, the priming discharge pulse 11a that is negative to the sustaining electrode standard potential is applied to the sustaining electrode 4. The priming discharge pulse 11b that is positive to the scanning electrode standard potential is applied to the scanning electrode 3. The priming discharge pulse 11c that is negative to the priming discharge electrode standard potential is applied to the priming discharge electrode 19. Then, the potential difference exceeding the discharge start voltage is given to the priming discharge gap 21 and the display gap 20, respectively, and the priming discharge is generated. After that, the priming erasing discharge pulse 12 that is negative to the scanning electrode standard potential is applied to the scanning electrode 3, and the priming erasing discharge is generated in both of the gaps (20,21). In the scanning period, a sub-scanning pulse 17c that is positive to the priming discharge electrode standard potential is applied to the priming discharge electrode 19. With the discharge generated between the scanning electrode 3 and the data electrode 8 as a trigger, the discharge in the priming discharge gap 21 is induced. At this time, a sub-scanning pulse 17 is not applied to the sustaining electrode 4, or the sub-scanning pulse 17 that is negative to the sustaining electrode standard potential is applied. It causes that the discharge in the display gap 20 is not generated. As a result, after the data-writing discharge, the negative wall charges are produced on the priming discharge electrode 19, and the positive wall charges are produced on the scanning electrode 3, respectively. The negative wall charges on the priming discharge electrode 19, the positive wall charges on the scanning electrode 3 and the negative sustaining pulse 15c applied to the priming discharge electrode are overlapped, and a first sustaining discharge is generated in the priming discharge gap 21. After the discharge, the positive wall charges are produced on the priming discharge electrode 19, and the negative wall charges are produced on the scanning electrode 3, and the respective polarities are opposite to those before the discharge generation. The wall charges after the first sustaining discharge and the negative sustaining pulse 15b applied to the scanning electrode 3 are overlapped to generate a second sustaining discharge in the priming discharge gap 21. After the discharge, the negative wall charges are produced on the priming discharge electrode 19, and the positive wall charges are produced on the scanning electrode 3, respectively. Next, when the negative sustaining pulse 15a is applied to the sustaining electrode 4, it is overlapped with the positive wall charges on the scanning electrode 3 which is produced by the second sustaining discharge, and a third sustaining discharge is generated in the display gap 20. After that, the sustaining discharge in the display gap 20 is repeated by the sustaining pulse rows to be alternately applied to the scanning electrode 3 and sustaining electrode 4. Here, by making the pulse width of the sustaining pulse 15c applied to the priming discharge electrode 19 wider, it is possible to surely shift from the data-writing discharge to the first sustaining discharge. After the sustaining period, the data-erasing pulse 16 that is negative to the scanning electrode standard potential is applied to the scanning electrode 3 so that the data-erasing discharge is generated in the cell in which the sustaining discharge continues. The positive wall charges produced on the priming discharge electrode 19 and sustaining electrode 4 and the negative wall charges produced on the scanning electrode 3, which respectively result from the above-mentioned sustaining discharge, and the negative data-erasing pulse 16 are overlapped. It causes that the data-erasing discharge is generated in both of the display gap 20 and the priming discharge gap 21.

With reference to FIG. 22, the priming discharge pulse 11a is not applied to the sustaining electrode 4. Thus, the discharge control operation similar to the driving waveform of FIG. 21 is generated except that the priming discharge and the priming erasing discharge are not generated in the display gap 20.

In the operation of the second embodiment, similarly to the first embodiment, since the priming discharge and the priming erasing discharge are generated in the display gap 20 in one subfield in one field, it is possible to make the discharging activity in the display gap 20 stronger. Also, it is possible to periodically initialize the wall charge distribution, and adapt to the motion image display. Therefore, it can suitably perform the addressing on the cell in the state of the black display for the long time, and then shift to the sustaining discharge. Also, such as the cases that the data-writing discharge is done in the priming discharge gap 21 and that most of the sustaining discharges are done in the display gap 20, the generation portion is changed. Thus, the driving waveform and cell structure, which is suitable for the generation of the data-writing discharge and the shift to the sustaining discharge, can be applied to the priming discharge gap 21, and the driving waveform and cell structure. For example, a high light emission efficiency or high charge withdrawal efficiency suitable for the sustaining discharge can be applied to the display gap 20, independently of each other. As a result, the various properties, which may have the tradeoff relations such as the stable generation of the data-writing discharge, the sure shift to the sustaining discharge, the high light emission efficiency and the high discharge withdrawal efficiency, can be obtained at the same time. For example, to generate the first sustaining discharge in the priming discharge gap 21, by applying the first sustaining pulse of the wide pulse width and/or the high peak value to the priming discharge electrode, it is possible to surely shift from the data-writing discharge to the first sustaining discharge. Also, by applying the sustaining pulse of the narrow pulse width and/or the low peak value to the scanning electrode and the sustaining electrode, it is possible to attain the sustaining discharge of the high light emission efficiency.

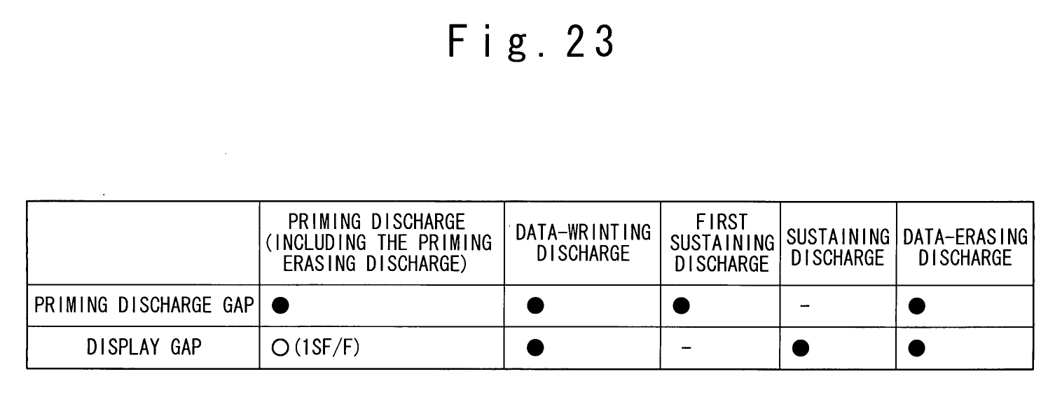

FIG. 23 is a view showing the discharge generation portion in the operation of a third embodiment of the present invention. The PDP has the same configuration as that of the first embodiment. With respect to driving the PDP, in the priming discharge gap 21, the priming discharge, the priming erasing discharge, the data-writing discharge, at least first sustaining discharge and the priming erasing discharge are generated in all of the subfields. In the display gap 20, the data-writing discharge, the sustaining discharges except at least first sustaining discharge, and the data-erasing discharge are generated in all of the subfields. Moreover, only in one subfield in one field, the priming discharge and the priming erasing discharge are generated in the display gap 20. In this embodiment, the structure is desired in which the priming discharge gap 21 is formed by using the priming discharge electrode 19 and the scanning electrode 3, in order to generate the data-writing discharge in the priming discharge gap 21.

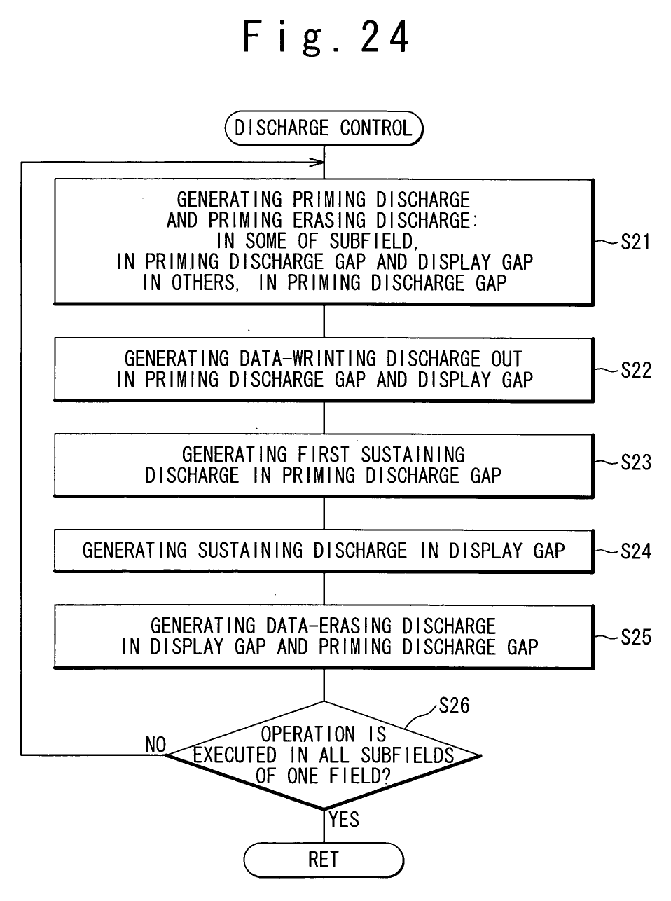

FIG. 24 is a flowchart showing an operation of the third embodiment according to the present invention. In this exemplified case, in the first subfield, the priming discharge and the priming erasing discharge are generated in the priming discharge gap 21 and the display gap 20. However, the present invention is not limited in the first subfield.

Firstly, in the first subfield, the priming discharge and the priming erasing discharge are generated in the priming discharge gap 21 and the display gap 20 (step S21). Next, the data-writing discharge is generated in priming discharge gap 21 and display gap 20 (step S22). Then, the first sustaining discharge is generated in the priming discharge gap 21 (step S23). After that, the sustaining discharge is generated in the display gap 20 (step S24). Next, the data-erasing discharge is generated in the priming discharge gap 21 and the display gap 20 (step S25). After that, as other subfields of one field remain (step S26: NO), the operation goes back to the step S21. On and after the second subfield, the priming discharge and the priming erasing discharge (S21) are generated in the priming discharge gap 21. Next, the data-writing discharge (S22) is generated in the priming discharge gap 21 and display gap 20. After that, the first sustaining discharge (S23) is generated in the priming discharge gap 21. Next, the sustaining discharge (S24) is generated in the display gap 20. Then, the data-erasing discharge (S25) is generated in the priming discharge gap 21 and the display gap 20. After that, if all subfields of one field are finished (S26: YES), the operation goes to the step S21 for a next field.

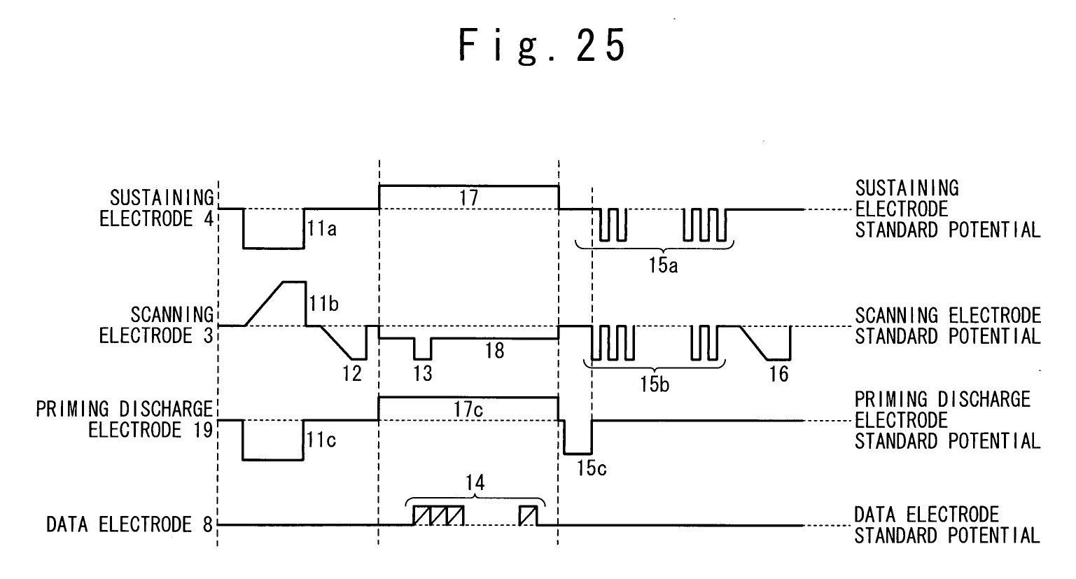

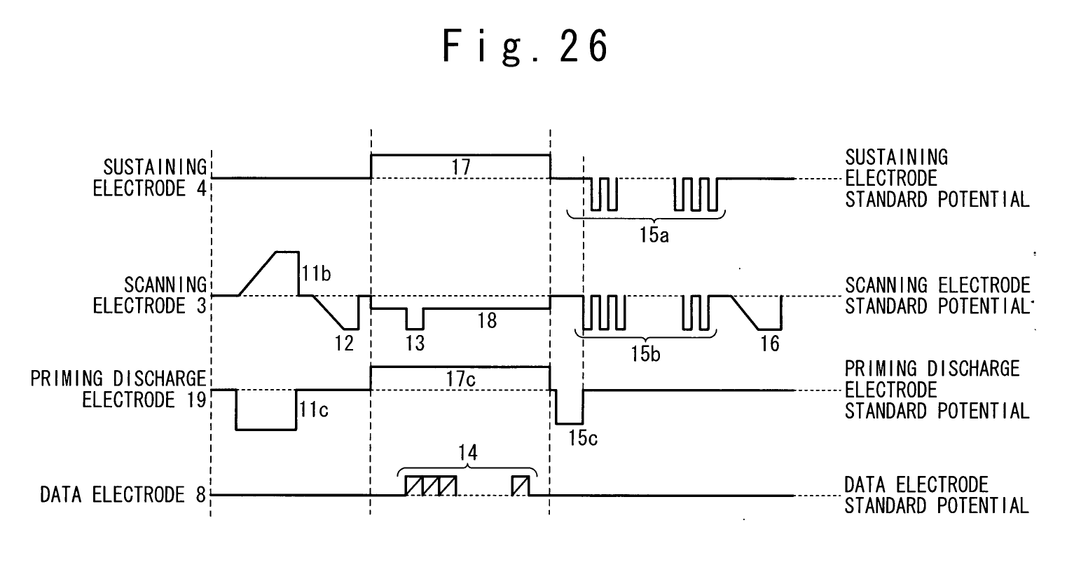

FIGS. 25 and 26 are driving waveforms when the discharge is generated in the discharge generation portion shown in FIG. 23 of the third embodiment. FIG. 25 is a view showing the driving waveform when the priming discharge is generated in both of the priming discharge gap 21 and the display gap 20. FIG. 26 is a view showing the driving waveform when the priming discharge is generated only in the priming discharge gap 21.

With reference to FIG. 25, the priming discharge pulse 11a that is negative to the sustaining electrode standard potential is applied to the sustaining electrode 4, and the priming discharge pulse 11b that is positive to the scanning electrode standard potential is applied to the scanning electrode 3. The priming discharge pulse 11c that is negative to the priming discharge electrode standard potential is applied to the priming discharge electrode 19. Then, the potential difference exceeding the discharge start voltage is given to the priming discharge gap 21 and the display gap 20, respectively, and the priming discharge is generated. In the scanning period, the sub-scanning pulse 17 that is positive to the sustaining electrode standard potential is applied to the sustaining electrode 4, and the sub-scanning pulse 17c that is positive to the priming discharge electrode standard potential is applied to the priming discharge electrode 19. Thus, with the discharge generated between the scanning electrode 3 and the data electrode 8 as the trigger, the discharge is induced in both of the display gap 20 and the priming discharge gap 21. As a result, after the data-writing discharge, the negative wall charges are produced on both of the priming discharge electrode 19 and the sustaining electrode 4, and the positive wall charges are produced on the scanning electrode 3, respectively. The negative wall charges on the priming discharge electrode 19 and the positive wall charges on the scanning electrode 3 and the negative sustaining pulse 15c applied to the priming discharge electrode are overlapped, and the first sustaining discharge is generated in the priming discharge gap 21. After the discharge, the positive wall charges are produced on the priming discharge electrode 19, and the negative wall charges are produced on the scanning electrode 3, and the respective polarities are opposite to those before the discharge generation. The wall charges after the first sustaining discharge and the negative sustaining pulse 15b applied to the scanning electrode 3 are overlapped to generate the second sustaining discharge in the priming discharge gap 21. After the discharge, the negative wall charges are produced on the priming discharge electrode 19, and the positive wall charges are produced on the scanning electrode 3, respectively. Next, when the negative sustaining pulse 15a is applied to the sustaining electrode 4, the positive wall charges on the scanning electrode 3 produced by the second sustaining discharge and the negative wall charges on the sustaining electrode 4 produced by the data-writing discharge are overlapped to generate the third sustaining discharge in the display gap 20.

With reference to FIG. 26, the priming discharge pulse 11a is not applied to the sustaining electrode 4. Thus, the discharge control operation similar to the driving waveform of FIG. 25 is generated except that the priming discharge and the priming erasing discharge are not generated in the display gap 20.

When the third sustaining discharge is generated within the sustaining period, which is firstly generated in the display gap 20 by the operation of the PDP based on the operation described in the third embodiment, the negative wall charges exist on the sustaining electrode 4. The total potential difference caused by the overlap of the potential difference resulting from the wall charges and the sustaining pulse 15a applied from the exterior becomes larger than the case that the wall charges do not exist on the sustaining electrode 4. Since the large potential difference is given, the effect that the generation of the sustaining discharge firstly generated in the display gap 20 becomes sure is obtained.

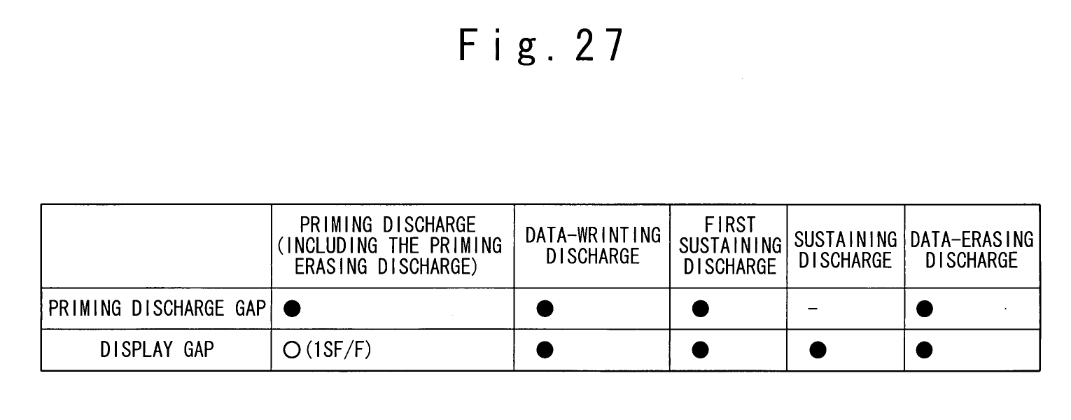

FIG. 27 is a view showing the discharge generation portion in a fourth embodiment of the present invention. The PDP has the same configuration as that of the first embodiment. With respect to driving the PDP, in the priming discharge gap 21, the priming discharge, the priming erasing discharge, the data-writing discharge, at least first sustaining discharge and the priming erasing discharge are generated in the subfield. In the display gap 20, the data-writing discharge, the sustaining discharges including the first sustaining discharge, and the data-erasing discharge are generated in all of the subfields. Moreover, only in one subfield in one field, the priming discharge and the priming erasing discharge are generated in the display gap 20. In this embodiment, the structure is desired in which the priming discharge gap 21 is formed by using the priming discharge electrode 19 and the scanning electrode 3, in order to generate the data-writing discharge in the priming discharge gap 21.

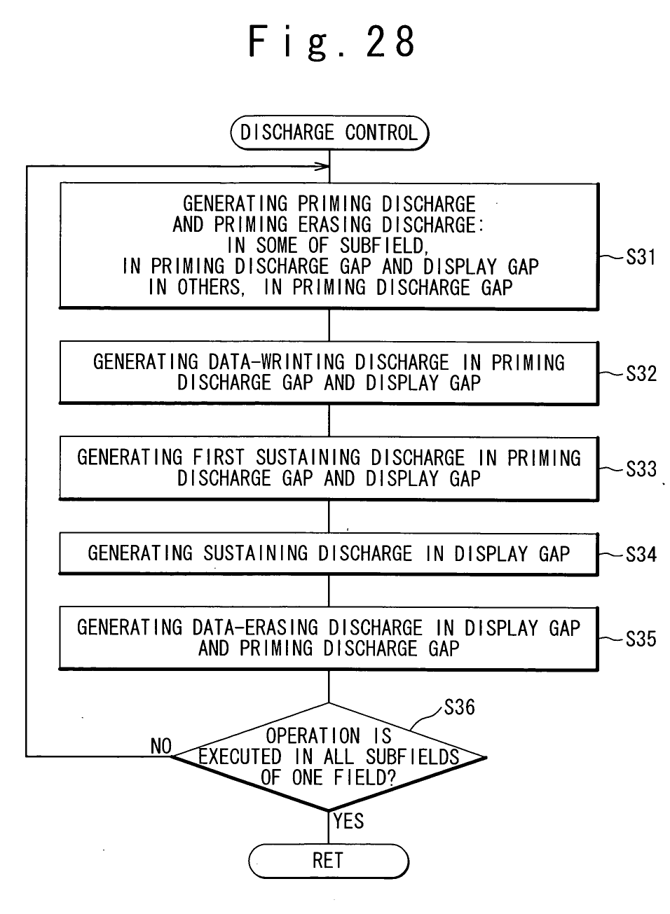

FIG. 28 is a flowchart showing an operation of the fourth embodiment according to the present invention. In this exemplified case, in the first subfield, the priming discharge and the priming erasing discharge are generated in the priming discharge gap 21 and the display gap 20. However, the present invention is not limited in the first subfield.

Firstly, in the first subfield, the priming discharge and the priming erasing discharge are generated in the priming discharge gap 21 and the display gap 20 (step S31). Next, the data-writing discharge is generated in the priming discharge gap 21 and the display gap 20 (step S32). Then, the first sustaining discharge is generated in the priming discharge gap 21 and the display gap 20 (step S33). After that, the sustaining discharge is generated in the display gap 20 (step S34). Next, the data-erasing discharge is generated in the priming discharge gap 21 and the display gap 20 (step S35). After that, as other subfields of one field remain (step S36: NO), the operation goes back to the step S31. On and after the second subfield, the priming discharge and the priming erasing discharge (S31) are generated in the priming discharge gap 21. Next, the data-writing discharge (S32) and the first sustaining discharge (S33) are generated in the priming discharge gap 21 and display gap 20. After that, the sustaining discharge (S34) is generated in the display gap 20. Then, the data-erasing discharge (S35) is generated in the priming discharge gap 21 and the display gap 20. After that, if all subfields of one field are finished (S36: YES), the operation goes to the step S31 for a next field.

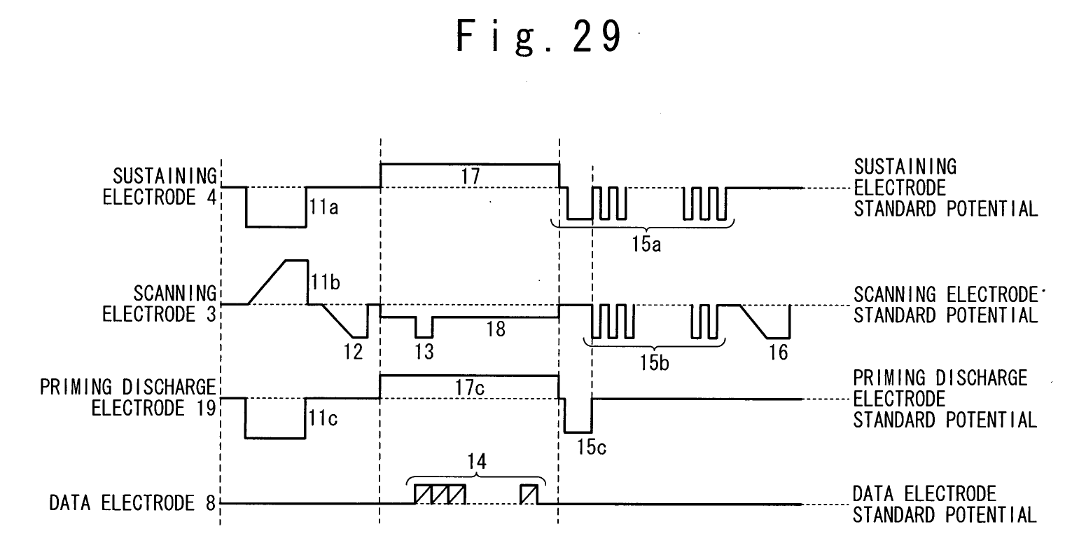

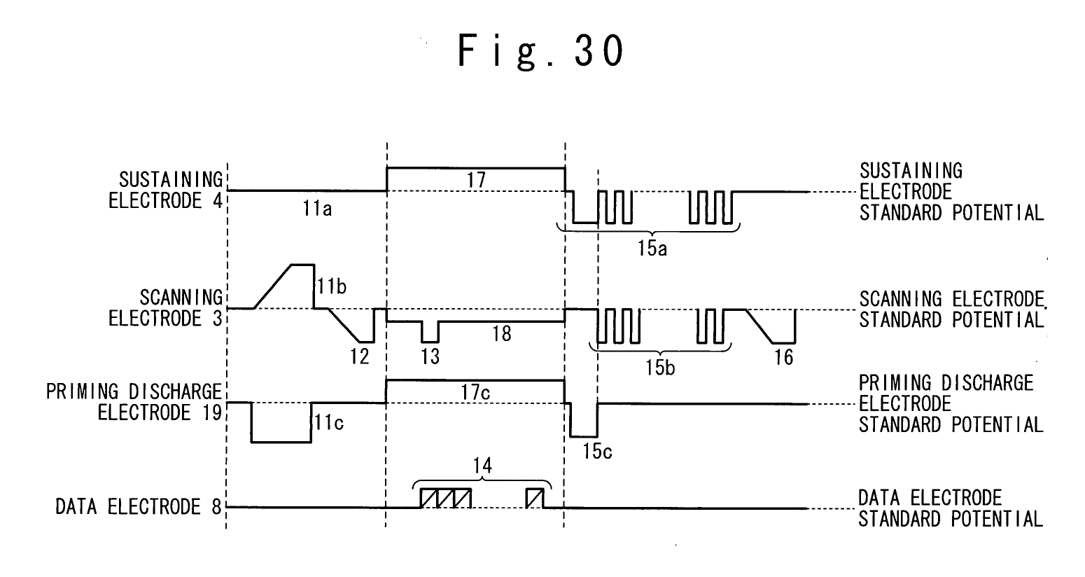

FIGS. 29 and 30 show the concrete driving waveforms when the discharge is generated in the discharge generation portion shown in FIG. 27 of the fourth embodiment. FIG. 29 is a view showing the driving waveform when the priming discharge is generated in both of the priming discharge gap 21 and the display gap 20. FIG. 30 is a view showing the driving waveform when the priming discharge is generated only in the priming discharge gap 21.

With reference to FIG. 29, the priming discharge pulse 11a that is negative to the sustaining electrode standard potential is applied to the sustaining electrode 4. The priming discharge pulse 11b that is positive to the scanning electrode standard potential is applied to the scanning electrode 3. The priming discharge pulse 11c that is negative to the priming discharge electrode standard potential is applied to the priming discharge electrode 19. Then, the potential difference exceeding the discharge start voltage is given to the priming discharge gap 21 and the display gap 20, respectively, and the priming discharge is generated. In the scanning period, in the data-writing discharge, after the discharge is induced in the display gap 20 and the priming discharge gap 21, the first sustaining pulse is applied to the sustaining electrode 4 and the priming discharge electrode 19. The first sustaining discharge is generated in both of the priming discharge gap 21 and the display gap 20.

With reference to FIG. 30, the priming discharge pulse 11a is not applied to the sustaining electrode 4. Thus, the discharge control operation similar to the driving waveform of FIG. 29 is generated except that the priming discharge and the priming erasing discharge are not generated in the display gap 20.

In the fourth embodiment, in the priming discharge gap 21 which is excellent in the shift property from the data-writing discharge to the sustaining discharge, the first sustaining discharge is surely generated, and a large number of active particles are created. Thus, the first sustaining discharge in the display gap 20 which is simultaneously generated is extremely increased in sureness. The third and fourth embodiments obtain the same effect of the sure shift to the sustaining discharge due to the configuration in which the first sustaining discharge is generated in the priming discharge gap 21.

In the explanations of the first to fourth embodiments, the configuration are described in which only in one subfield in one field, the priming discharge and the priming erasing discharge are generated in the display gap 20. However, this frequency is merely one embodiment of the present invention. It is naturally possible to generate the proper adjustment, such as the higher frequency (for example, two subfields in one field) or the lower frequency (for example, one subfield in two fields) or the like. At this time, if in all of the subfields, the priming discharge is generated in the display gap 20, the black brightness drop effect is lost, which is the greatest merit of the PDP having the priming discharge electrode. Thus, naturally, the priming discharge generation frequency in the display gap 20 is at least reduced over the number of all subfields. Thus, the following effects can be obtained. That is, if the priming discharge generation frequency in the display gap 20 is made higher, the discharge activity degree of the display gap 20 is further increased, and if the priming discharge generation frequency in the display gap 20 is made lower, the black brightness can be dropped.

Also, the configuration is described in which in all of the subfields, the priming discharge and the priming erasing discharge are generated in the priming discharge gap 21. However, the mechanism in which in some of the subfields, the priming discharge is not generated in the priming discharge gap 21 (the partial omission) is included in the configuration of the present invention. If the supply amount of the active particle density that is the function of the priming discharge exceeds the necessary amount within the field, even the reduction in the number of the priming discharges does not cause the trouble of the drive. The mechanism in which in some of the subfields, the priming discharge is not generated in the priming discharge gap 21 can drop the black brightness.

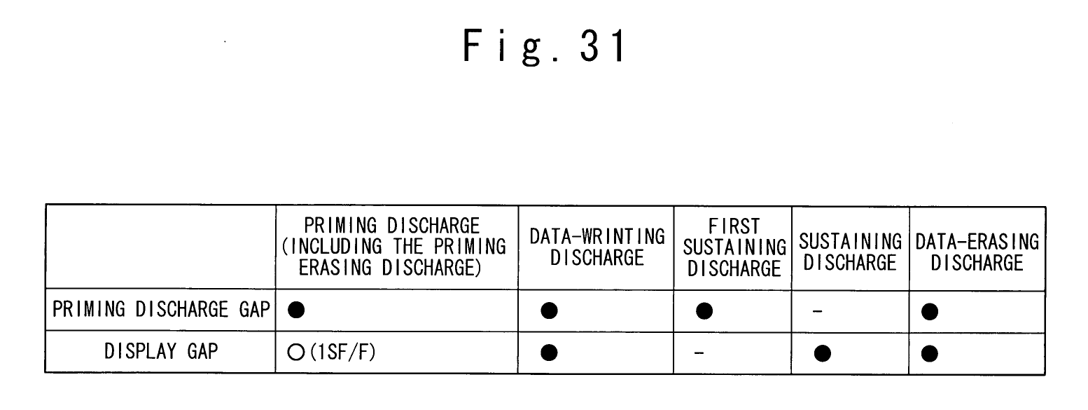

FIG. 31 is a view showing the discharge generation portion in a fifth embodiment of the present invention. The PDP has the same configuration as that of the first embodiment. With respect to driving the PDP, in some of the subfields, the priming discharge and the priming erasing discharge are generated only in the priming discharge gap 21. In the remaining subfields, the priming discharge and the priming erasing discharge are generated only in the display gap 20. Moreover, in all of the subfields, the data-writing discharge, at least first sustaining discharge and the priming erasing discharge are generated in the priming discharge gap 21. The data-writing discharge, the sustaining discharges except at least first sustaining discharge, and the priming erasing discharge are generated in the display gap 20. In this embodiment, the structure is desired in which the priming discharge gap 21 is formed by using the priming discharge electrode 19 and the scanning electrode 3, in order to generate the data-writing discharge in the priming discharge gap 21.

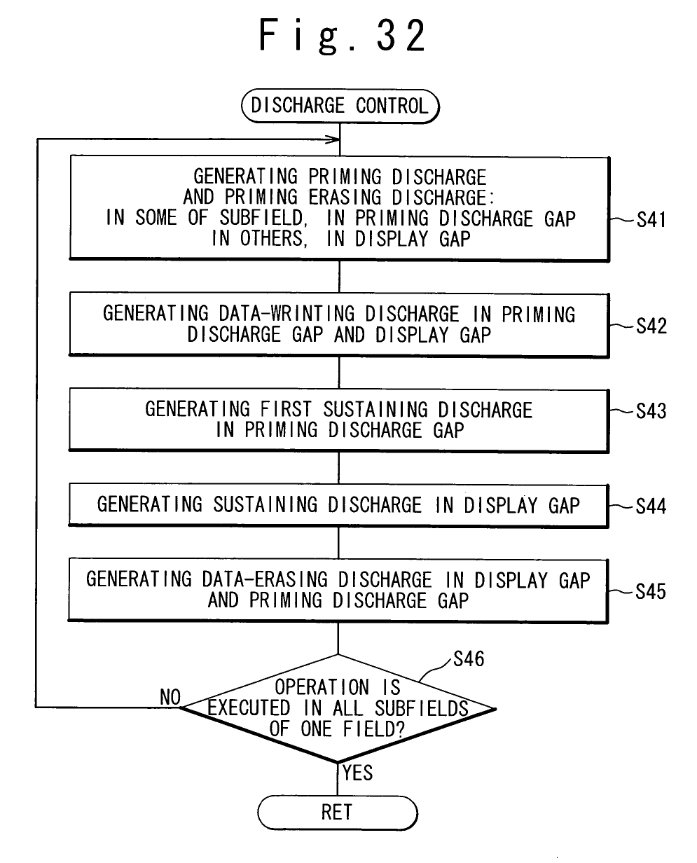

FIG. 32 is a flowchart showing an operation of the fifth embodiment according to the present invention. In this exemplified case, in the first subfield, the priming discharge and the priming erasing discharge are generated in the priming discharge gap 21 and the display gap 20. However, the present invention is not limited in the first subfield.

Firstly, in the first subfield, the priming discharge and the priming erasing discharge are generated in the priming discharge gap 21 (step S41). Next, the data-writing discharge is generated in the priming discharge gap 21 and the display gap 20 (step S42). Then, the first sustaining discharge is generated in the priming discharge gap 21 (step S43). After that, the sustaining discharge is generated in the display gap 20 (step S44). Next, the data-erasing discharge is generated in the priming discharge gap 21 and the display gap 20 (step S45). After that, as other subfields of one field remain (step S46: NO), the operation goes back to the step S41. On and after the second subfield, the priming discharge and the priming erasing discharge (S41) are generated in the display gap 21. Next, the data-writing discharge (S42) is generated in the priming discharge gap 21 and display gap 20. The first sustaining discharge (S43) is generated in the priming discharge gap 21. After that, the sustaining discharge (S44) is generated in the display gap 20. Then, the data-erasing discharge (S45) is generated in the priming discharge gap 21 and the display gap 20. After that, if all subfields of one field are finished (S46: YES), the operation goes to the step S41 for a next field.

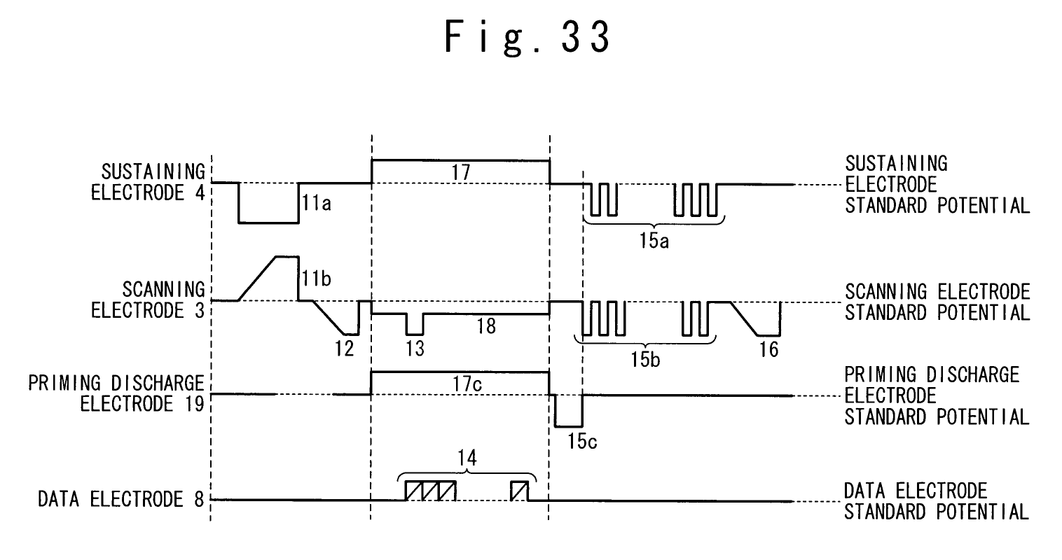

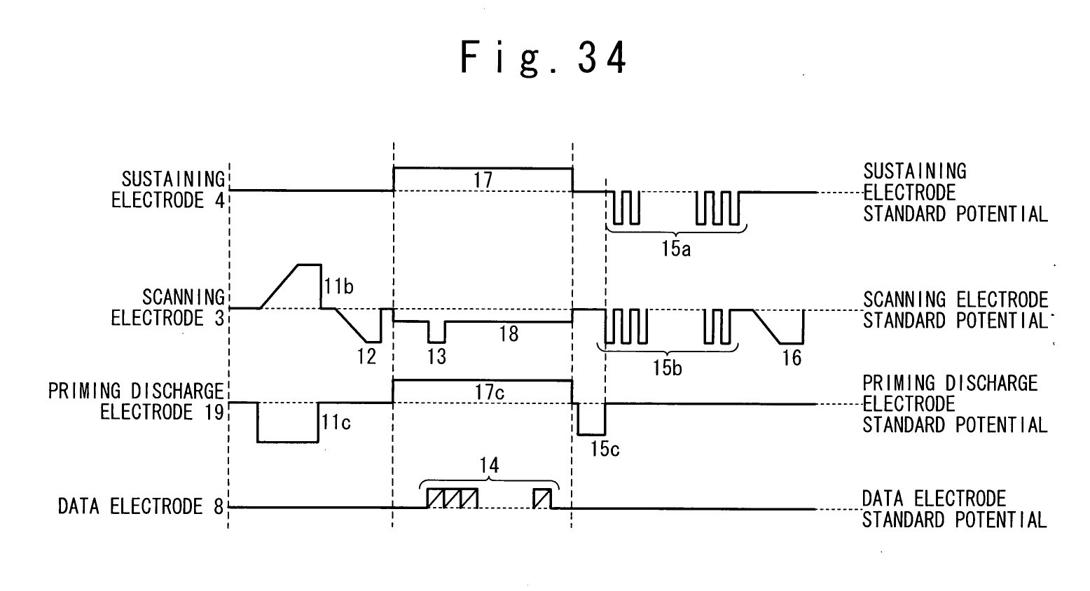

FIGS. 33 and 34 are driving waveforms when the discharge is generated in the discharge generation portion shown in FIG. 31. FIG. 33 is a view showing the driving waveform when the priming discharge is generated in both of the priming discharge gap 21 and the display gap 20. FIG. 34 is a view showing the driving waveform when the priming discharge is generated only in the priming discharge gap 21.

With reference to FIG. 33, the priming discharge pulse 11a that is negative to the sustaining electrode standard potential is applied to the sustaining electrode 4, and the priming discharge pulse 11b that is positive to the scanning electrode standard potential is applied to the scanning electrode 3. Then, the potential difference exceeding the discharge start voltage is given to only the display gap 20, and the priming discharge is generated. After that, the priming erasing discharge pulse 12 that is negative to the scanning electrode standard potential is applied to the scanning electrode 3, and the priming erasing discharge is generated only in the display gap 20.

With reference to FIG. 34, the priming discharge pulse 11c that is negative to the priming discharge electrode standard potential is applied to the priming discharge electrode 19, and the priming discharge pulse 11b that is positive to the scanning electrode standard potential is applied to the scanning electrode 3. Then, the potential difference exceeding the discharge start voltage is given to only the priming discharge gap 21, and the priming discharge is generated. After that, the priming erasing discharge pulse 12 that is negative to the scanning electrode standard potential is applied to the scanning electrode 3, and the priming erasing discharge is generated only in the priming discharge gap 21.

In the scanning periods of all of the subfields, by applying the sub-scanning pulse 17 to the sustaining electrode 4 and applying the sub-scanning pulse 17c to the priming discharge electrode 19, it is possible to generate the data-writing discharge in both of the display gap 20 and the priming discharge gap 21 to obtain the same inventive effect as the third embodiment of the present invention. Moreover, in this embodiment, when the priming discharge is generated in the display gap 20, the priming discharge in the priming discharge gap 21 is omitted, which enables the black brightness to be dropped over the third embodiment. In order to avoid the discharge activity degree in the display gap 20 and the discharge activity degree in the priming discharge gap 21 from being excessively weak, the subfield (FIG. 33) in which the priming discharge is done only in the display gap 20 and the subfield (FIG. 34) in which the priming discharge is done only in the priming discharge gap 21 are both desired such that one subfield is arranged in at least one field.

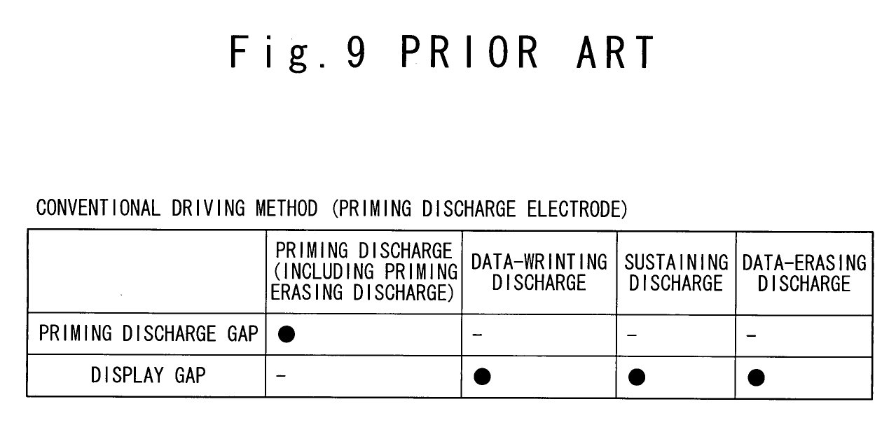

Next, the sixth embodiment of the present invention will be described. The PDP has the same configuration as that of the first embodiment. In the usual operation, the discharge generation portion in a sixth embodiment is the same as that shown in FIG. 9. However, if the subfields, in which few PDP cells are discharged, are continued sequentially, one of the operations of the first to fifth embodiments is generated for a predetermined number of fields. In this way, even if the subfields, in which few PDP cells emit light (are discharged), are continued sequentially, by generating the priming discharge in the display gap, it becomes possible to execute addressing and generating the sustaining discharge surely.

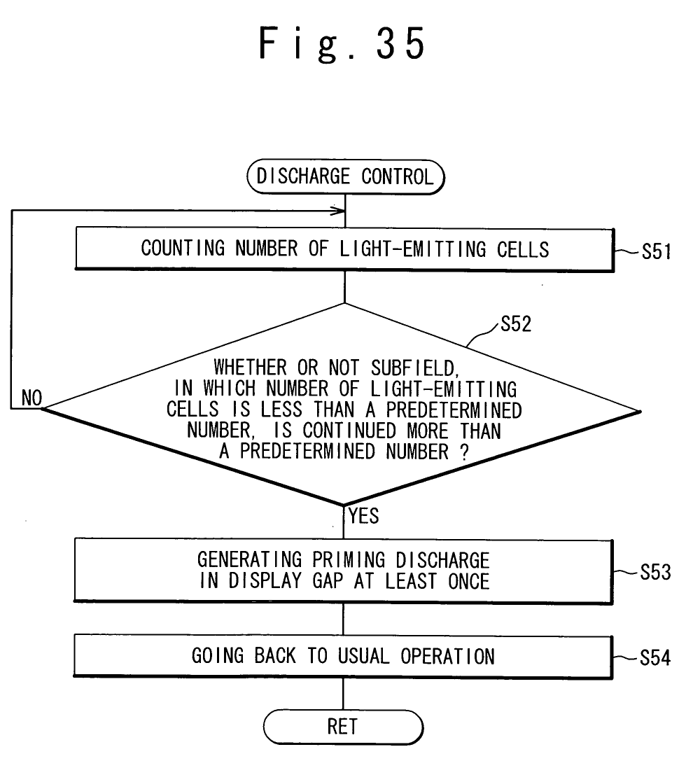

FIG. 35 is a flowchart showing an operation of the sixth embodiment of the present invention.

The input interface signal processor of drive control section 41 counts the number of light-emitting cells (the discharged PDP cells) of each subfield (step s51). The counting results are stored in a memory device (not shown) with respect to each 1 to 10 fields, as a history data. In the history data, the subfield is related to the number of light-emitting cell. With reference to the history data (the number of the light-emitting cells in each subfield), the input interface signal processor judges the predetermined condition. The predetermined condition is whether or not the subfields, in which the number of the light-emitting cells is less than a predetermined number, is continued sequentially more than a predetermined number (ex. 10 subfields). If the input interface signal processor judges that the condition is satisfied (step S52: YES), the operation, in which the priming discharge is generated in the display gap 20, is operated at least once (step S53). Here, the operation, in which the priming discharge is generated in the display gap 20, is at least one of the operations of the first to fifth embodiments. After that, the history data is reset, and the operation goes back to the usual operation (step S54).

To detect the history data precisely, another method is also available. The method is as follows. Firstly, the input interface signal processor of drive control section 41 partitions one screen among a plurality of blocks. Then, the input interface signal processor counts the number of light emitting cell (the discharged PDP cells) of each block of each subfield to detect the minimum number of the light-emitting cells (step s51). The counting results are stored in a memory device (not shown) with respect to each 1 to 10 fields, as the history data. With reference to the history data, the input interface signal processor judges the predetermined condition. The predetermined condition is whether or not the subfields, in which the minimum number of the light-emitting cells of the block is less than a predetermined number, is continued sequentially more than a predetermined number (ex. 10 subfields). If the input interface signal processor judges that the condition is satisfied (step S52: YES), the operation, in which the priming discharge is generated in the display gap 20, is operated at least once (step S53).

The smaller the number of PDP cells, the more the degree of precision is improved. In this case, the circuit may be enlarged. By generating experiments for which various display patterns are used, a typical history data can be obtained for each PDP. By using the obtained history data, the priming discharge can be generated in the display gap in a suitable timing. Also, by using the obtained history data, the priming discharge can be generated in the display gap and priming discharge gap in a suitable timing.

The above-mentioned method, for example, the PDP cells, which does not emit in the 10 subfields continuously, can be detected roughly. If that PDP cell is detected, by generating the priming discharge in the display gap, it becomes possible to execute addressing and generating the sustaining discharge surely.

As the effect of the present invention, in driving the PDP having the priming discharge electrode 19, independently of the scanning electrode 3 and the sustaining electrode 4, at the position which is located on the front substrate and between the adjacent cells, at the frequency of about one subfield in one field, the priming discharge and the priming erasing discharge are generated even in the display gap. Thus, the discharge activity in the display gap of the cell in the state of the black display for the long time can be increased, thereby generating the sustaining discharge surely. Consequently, it is possible to obtain the PDP having the high displaying quality.

What is claimed is:

1. A plasma display apparatus comprising:
a plasma display panel; and
a driving control section which outputs drive control signals to drive said plasma display panel,
wherein said plasma display panel comprises:
a front substrate, and
a rear substrate which is faced to said front substrate,
discharge spaces are formed between said front substrate and said rear substrate,
said front substrate includes:
a plurality of sets of front electrodes, each of which is extended toward a first direction, and includes a scanning electrode, a sustaining electrode and a priming discharge electrode,
one of a gap between said scanning electrode and said priming electrode and a gap between said sustaining electrode and said priming electrode is formed as a priming discharge gap where a discharge is generated,
a gap between said scanning electrode and said sustaining electrode is formed as a display gap where a discharge is generated,
said rear substrate includes:
a plurality of data electrodes which extends toward a second direction,
said drive control signals include a first drive control signal, which indicates an operation of distributing a field into a plurality of subfields, generating a priming discharge in said priming discharge gap in said plurality of the subfields, and generating said priming discharge in said display gap in at least one of said plurality of the subfields, and
said plasma display panel is driven based on said first drive control signal.

2. The plasma display apparatus according to claim 1, wherein said priming discharge gap is the gap between said scanning electrode and said priming electrode,
said first drive control signal includes a second drive control signal, which indicates an operation of generating a discharge in a gap between said scanning electrode and one of said plurality of said data electrode by applying a data pulse to said one data electrode synchronous to a scanning pulse applied to said scanning electrode, setting a potential difference of said priming discharge gap to be larger than the first threshold and smaller than the second threshold when said scanning pulse is applied, generating a sustaining discharge after discharging in the gap between said scanning electrode and said one data electrode while generating at least a first sustaining discharge in said priming discharge gap,
said first threshold is that a discharge is generated in said priming discharge gap when a discharge is generated between said scanning electrode and said one data electrode, said second threshold is that a discharge is generated in said priming discharge gap when a discharge is not generated between said scanning electrode and said one data electrode.

3. The plasma display apparatus according to claim 2, wherein said first drive control signal includes a third drive control signal, which indicates an operation of generating at least said first sustaining discharge in said priming discharge gap, generating other sustaining discharge in said displaying gap, and generating a data-erasing discharge in said priming discharge gap and said displaying gap, said data-erasing discharge initializes a distribution of charges in said discharge space.

4. The plasma display apparatus according to claim 2, wherein said first drive control signal includes a fourth drive control signal, which indicates an operation of generating said sustaining discharge including a first sustaining discharge in said display gap, and generating a data-erasing discharge in said priming discharge gap and said displaying gap, said data-erasing discharge initializes a distribution of charges in said discharge space.

5. The plasma display apparatus according to claim 3, wherein said first drive control signal includes a fifth drive control signal, which indicates an operation of generating said data-erasing discharge in said priming discharge gap and said displaying gap simultaneously.

6. The plasma display apparatus according to claim 2, wherein said first drive control signal includes a sixth drive control signal, which indicates an operation of setting a potential difference of said display gap to be larger than the third threshold and smaller than the fourth threshold when said scanning pulse is applied,
said third threshold is that a discharge is generated in said display gap when a discharge is generated between said scanning electrode and said one data electrode, said fourth threshold is that a discharge is generated in said display gap when a discharge is not generated between said scanning electrode and said one data electrode.

7. The plasma display apparatus according to claim 1, wherein said first drive control signal includes a seventh drive control signal, which indicates an operation of generating said priming discharge in said priming discharge gap in each of said plurality of the subfields.

8. The plasma display apparatus according to claim 1, wherein said first drive control signal includes a eighth drive control signal, which indicates an operation of generating said priming discharge only in said display gap in at least one of said plurality of the subfields.

9. The plasma display apparatus according to claim 1, wherein said first drive control signal includes a ninth drive control signal, which indicates an operation of generating said priming discharge only in said priming discharge gap in at least one of said plurality of the subfields, and generating said priming discharge only in said display gap in remaining of said plurality of the subfields.

10. The plasma display apparatus according to claim 1, wherein said driving control section includes:
a history detecting section which detects a history data of generating of display discharges in said display gap, and judges whether or not said priming discharge is generated in said displaying gap based on said history data.

11. The plasma display apparatus according to claim 10, wherein said history data includes a number of light-emitting of cells in at least one of a predetermined area and a predetermined time period.

12. A driving method of a plasma display panel included in a plasma display apparatus which includes:
said plasma display panel; and
a driving control section which outputs drive control signals to drive said plasma display panel,
wherein said plasma display panel includes:
a front substrate, and
a rear substrate which is faced to said front substrate,
a discharge space is formed between said front substrate and said rear substrate,
said front substrate includes:
a plurality of sets of front electrodes, each of which is extended toward a first direction, and includes a scanning electrode, a sustaining electrode and a priming discharge electrode,
one of a gap between said scanning electrode and said priming electrode and a gap between said sustaining electrode and said priming electrode is formed as a priming discharge gap where a discharge is generated,
a gap between said scanning electrode and said sustaining electrode is formed as a display gap where a discharge is generated,
said rear substrate includes:
a plurality of data electrodes which extends toward a second direction,
comprising:
(a) distributing a field into a plurality of subfields;
(b) generating a priming discharge in said priming discharge gap in said plurality of the subfields; and
(c) generating said priming discharge in said display gap in at least one of said plurality of the subfields.

13. A driving method of a plasma display panel that said priming discharge gap is the gap between said scanning electrode and said priming electrode, according to claim 12, further comprising:
(d) generating a discharge in a gap between said scanning electrode and one of said plurality of said data electrode by applying a data pulse to said one data electrode synchronous to a scanning pulse applied to said scanning electrode; and
(e) generating a sustaining discharge after discharging in the gap between said scanning electrode and said one data electrode while generating at least a first sustaining discharge in said priming discharge gap,
wherein a potential difference of said priming discharge gap is larger than the first threshold and smaller than the second threshold when said scanning pulse is applied, said first threshold is that a discharge is generated in said priming discharge gap when a discharge is generated between said scanning electrode and said one data electrode, said second threshold is that a discharge is generated in said priming discharge gap when a discharge is not generated between said scanning electrode and said one data electrode.

14. The driving method of a plasma display panel according to claim 13, further comprising:
(f) generating a data-erasing discharge in said priming discharge gap and said displaying gap,
wherein said data-erasing discharge initializes a distribution of charges in said discharge space,
said step (e) includes:
(e1) generating at least said first sustaining discharge in said priming discharge gap, and
(e2) generating other sustaining discharge in said displaying gap.

15. The driving method of a plasma display panel according to claim 13, further comprising:
(f) generating a data-erasing discharge in said priming discharge gap and said displaying gap,
wherein said data-erasing discharge initializes a distribution of charges in said discharge space,
said step (e) includes:
(e3) generating said sustaining discharge including a first sustaining discharge in said display gap.

16. The driving method of a plasma display panel according to claim 14, wherein said step (f) includes:
(f1) generating said data-erasing discharge in said priming discharge gap and said displaying gap simultaneously.

17. The driving method of a plasma display panel according to claim 13, wherein a potential difference of said display gap is set to be larger than the third threshold and smaller than the fourth threshold when said scanning pulse is applied, and
said third threshold is that a discharge is generated in said display gap when a discharge is generated between said scanning electrode and said one data electrode, said fourth threshold is that a discharge is generated in said display gap when a discharge is not generated between said scanning electrode and said one data electrode.

18. The driving method of a plasma display panel according to claim 12, wherein said step (b) includes:
(b1) generating said priming discharge in said priming discharge gap in each of said plurality of the subfields.

19. The driving method of a plasma display panel according to claim 12, wherein said step (c) includes:
(c1) generating said priming discharge in said display gap in each of said plurality of the subfields.

20. The driving method of a plasma display panel according to claim 12, wherein said step (c) includes:
(c2) generating said priming discharge in said display gap in one of said plurality of the subfields.

21. The driving method of a plasma display panel according to claim 12, wherein said step (b) includes:
(b1) generating said priming discharge only in said priming discharge gap in at least one of said plurality of the subfields,
said step (c) includes:
(c3) generating said priming discharge only in said display gap in remaining of said plurality of the subfields.

22. The driving method of a plasma display panel according to claim 12, futher comprising:
(g) detecting a history data of generating of display discharges in said display gap, and
(h) judging whether or not said priming discharge is generated in said displaying gap based on said history data.

23. The driving method of a plasma display panel according to claim 22, wherein said history data includes a number of light-emitting of cells in at least one of a predetermined area and a predetermined time period.

24. A plasma display apparatus which includes:
a front substrate; and
a rear substrate faced to said front substrate,
wherein a plurality of discharge spaces is formed between said front substrate and said rear substrate,
a priming discharge gap and a display discharge gap are formed in each of said plurality of discharge spaces,
one field is distributed into a plurality of subfields for displaying image data,
characterized in that a priming discharge is generated in said display discharge gap in at least one of another plurality of said subfields.

25. A plasma display apparatus which includes:
a front substrate; and
a rear substrate faced to said front substrate,
wherein a plurality of discharge spaces is formed between said front substrate and said rear substrate,
a display discharge gap and a priming discharge gap corresponding to said display discharge gap are formed in each of said plurality of discharge spaces,
one field is distributed into a plurality of subfields for displaying image data,
characterized in that a priming discharge generated in said display discharge gap is controlled based on a history of display discharges generated in said display discharge gap.
